(19) United States
(12) Patent Application Publication
(10) Pub. No.: US 2026/0332296 A1
(43) Pub. Date: Oct. 22, 2026

(54) CODE BLOCK BUNDLE INTERLEAVED SPATIAL COUPLED CODED MIMO

(71) Applicant: QUALCOMM Incorporated, San Diego, CA (US)

(72) Inventors: Somsubhra BARIK, San Diego, CA (US); Wei YANG, San Diego, CA (US); Jing SUN, San Diego, CA (US)

(21) Appl. No.: 19/186,459

(22) Filed: Apr. 22, 2025

(51) Int. Cl. H04L 1/00; H04W 76/20

(52) U.S. Cl. CPC H04L 1/0057; H04L 1/0005; H04L 1/0071; H04W 76/20

(57) ABSTRACT

The apparatus may be a transmitting wireless device configured to obtain a plurality of code blocks (CBs) of a first codeword, wherein each CB of the plurality of the CBs is associated with a corresponding set of resource elements (REs), wherein each set of REs comprises a plurality of subsets of REs, generate a CB bundle (CBB) comprising the plurality of the CBs, wherein the CBB is associated with a first ordering of the plurality of the CBs, generate a plurality of CBB cycles associated with the CBB by interleaving, based on the first ordering of the plurality of the CBs, the subsets of the REs associated with the plurality of the CBs, apply, to the plurality of the CBB cycles, a staggered resource mapping across a plurality of layers, and transmit the plurality of the CBs based on the staggered resource mapping across the plurality of the layers.

### TECHNICAL FIELD

The present disclosure relates generally to communication systems, and more particularly, to multiple input multiple output (MIMO) wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of later wireless communication, such as 6G or others, may be based on aspects of 5G NR and/or 4G LTE. There exists a need for further improvements in 5G NR technology and additional wireless communication technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a transmitting wireless device such as a user equipment (UE) or network device configured to obtain a plurality of code blocks (CBs) of a first codeword, wherein each CB of the plurality of the CBs is associated with a corresponding set of resource elements, wherein each set of resource elements comprises a plurality of subsets of resource elements, generate a CB bundle (CBB) comprising the plurality of the CBs, wherein the CBB is associated with a first ordering of the plurality of the CBs, generate a plurality of CBB cycles associated with the CBB by interleaving, based on the first ordering of the plurality of the CBS, the subsets of the resource elements associated with the plurality of the CBs, apply, to the plurality of the CBB cycles, a staggered resource mapping across a plurality of layers, and transmit, via the plurality of the layers, the plurality of the CBs based on the staggered resource mapping across the plurality of the layers.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating resources that may be used to transmit a set of CBs based on a SC-MIMO mapping.

FIG. 4B is a diagram illustrating a mapping of data associated with each CB according to a SC-MIMO implementation.

FIG. 4C illustrates is a diagram illustrating an example of CBGs that are derived from a TB.

FIG. 5 is a diagram illustrating an example of code block bundling.

FIG. 6 is a set of diagrams illustrating different implementations of a CBB-based layer mapping (e.g., a CBB-based SC-MIMO or CBB-based staggered layer mapping).

FIG. 7 is a call flow diagram illustrating a method of wireless communication in accordance with some aspects of the disclosure.

FIG. 8 is a flowchart of a method of wireless communication.

FIG. 9 is a flowchart of a method of wireless communication.

FIG. 10 is a diagram illustrating an example of a hardware implementation for an apparatus.

FIG. 11 is a diagram illustrating an example of a hardware implementation for a network entity.

### DETAILED DESCRIPTION

In some aspects of wireless communication, data for transmission may be organized at multiple levels, e.g., a transport block (TB) may include one or more CB groups, each CB group may include one or more CBs. Additionally, multiple CBs may be combined to produce one or more codewords. A transmitting wireless device may communicate the one or more codewords using a multiple-input multiple-output (MIMO) (or multiple-input single-output (MISO)) architecture (or method) such that code blocks of a codeword are mapped to multiple spatial layers (e.g., communicated using various antenna ports or demodulated reference signal (DMRS) ports of the wireless device) and/or multiple time-frequency resources. In some aspects, different codewords may be mapped to different respective layers. For example, a wireless device may transmit multiple code blocks of a codeword using a single spatial layer over multiple time-frequency resources (e.g., resource blocks (RBs) or resource elements (REs)). In some aspects, a wireless device may map a single codeword to multiple layers (and over multiple time-frequency resources, e.g., RBs or REs). For example, a wireless device operating in a 5G NR system may transmit different code blocks of a single codeword over multiple layers and multiple radio-frequency resources. In some aspects, a wireless device may use multiple spatial layers in a single time-frequency resource to transmit a same code block (e.g., repetitions of a single code block) or different code blocks.

In some aspects, a transmitting wireless device (e.g., a transmitter or transmitting device) may apply a “spatially coupled” coded MIMO (SC-MIMO) as a rate matching feature for multi-layer transmission schemes. The SC-MIMO, in some aspects, may apply a mapping similar to a Bell Labs layered space-time (BLAST) architecture/structure (e.g., a diagonal BLAST or D-BLAST structure). A D-BLAST like layer mapping may, in some aspects, allow each code block in a TB to have non-overlapping footprints in at least one of a frequency domain and a time domain across transmission layers. In some aspects, the SC-MIMO may be viewed as a layer-specific (or group of layer-specific) staggering of code blocks in the time and frequency domains (or in a combined time-and-frequency domain) for a transmission. A wireless device receiving an SC-MIMO transmission (e.g., a receiver or receiving device), in some aspects, may perform a decoding and/or detection of the individual code blocks that involves a sequential de-mapping and/or demodulating and decoding on a CB-by-CB basis. In some aspects, one or more code blocks that are easiest to decode (“special CBs”) may be passed through (or processed based on) the demodulation and decoding operations at the receiver. The receiver may then, based on the decoded one or more CBS (e.g., the “special CBs”), subtract the corresponding signal from a received signal (e.g., a raw signal) to facilitate a demodulation and decoding of subsequent code blocks. The iterative, or sequential, demodulation and decoding, in some aspects, may be performed in a manner similar to a “successive cancellation.” When using the SC-MIMO with layer-specific rate matching of each CB, the footprint of each CB in a time/frequency domain may be limited to the number of REs (or RBs) to which each CB is rate matched. In some aspects, the transmitter may additionally perform a precoding resource group (PRG) based frequency interleaving to increase a frequency diversity (e.g., to expand a frequency span associated with the CB or the RBs to which the CB is mapped, where a frequency span may refer to a frequency difference between a highest frequency resource/RB and a lowest frequency resource/RB associated with, or used to transmit, the CB) based on the number of PRGs associated with a CB. For a high modulation and coding scheme (MCS) and/or high rank transmission, the number of PRGs making up, included in, or associated with, a CB may be limited. For example, for an 8K bit CB with code rate 0.9 using 256QAM and rank 4 transmission, the CB will only occupy about 23R Bs or roughly 6 PRGs (assuming PRG size of 4 RBs). For this example, the footprint of a CB may be expanded by a factor of 4×6 (the number of layers x the number of PRGs per CB) and may experience reduced benefits of frequency diversity. In some aspects, the reduced frequency diversity may be further affected when an underlying channel is less selective (e.g., with giga MIMO (gMIMO) beamforming).

Various aspects relate generally to the introduction of frequency interleaving based on code block bundling (CBB) to a staggered SC-MIMO. In some aspects, introducing frequency diversity by interleaving CBs in a code block bundle (CBB) may increase a rate loss based on the larger size of a CBB unit and corresponding set of empty resources to allow for a decoding of a first CBB unit. Some aspects more specifically relate to methods to reduce rate loss by manipulating a staggering method (or introducing a modified staggering method) such that, instead of having empty resources corresponding to a full CBB, the empty resources correspond to a subset of the CBs in the CBB. In some examples, configured to obtain a plurality of CBs of a first codeword, wherein each CB of the plurality of the CBs is associated with a corresponding set of resource elements, wherein each set of resource elements comprises a plurality of subsets of resource elements, generate a CBB comprising the plurality of the CBs, wherein the CBB is associated with a first ordering of the plurality of the CBs, generate a plurality of CBB cycles associated with the CBB by interleaving, based on the first ordering of the plurality of the CBs, the subsets of the resource elements associated with the plurality of the CBs, apply, to the plurality of the CBB cycles, a staggered resource mapping across a plurality of layers, and transmit, via the plurality of the layers, the plurality of the CB s based on the staggered resource mapping across the plurality of the layers.

Particular aspects of the subject matter described in this disclosure can be implemented to realize one or more of the following potential advantages. In some examples, by introducing frequency diversity by interleaving CBs in a code block bundle using the modified staggering method, the described techniques can be used to improve the frequency diversity for a CB while maintaining a rate loss associated with the unmodified staggering method.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspects. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

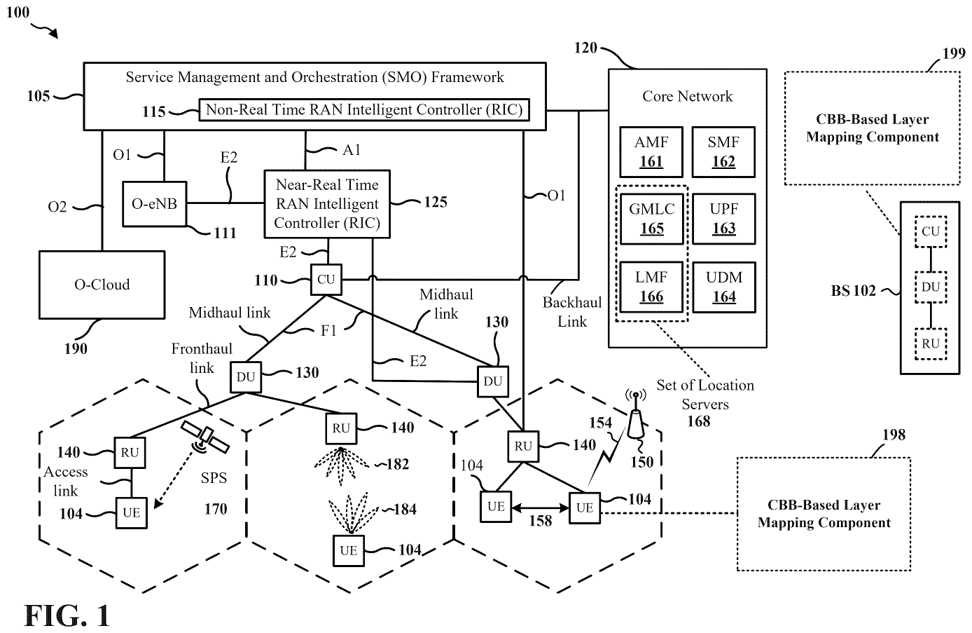

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRA CH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eN B (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eN B, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/U Es 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR 2 (24.25 GHZ-52.6 GHz). Although a portion of FR 1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR 1 and FR 2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR 1 and/or FR 2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR 4 (71 GH z-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR 1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IA B) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SM F) 162, a User Plane Function (UPF) 163, a Unified Data Management (UDM) 164, one or more location servers 168, and other functional entities. The A M F 161 is the control node that processes the signaling between the UEs 104 and the core network 120. The AMF 161 supports registration management, connection management, mobility management, and other functions. The SM F 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SM LC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NRE-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of U Es 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a CBB-based layer mapping component 198 that may be configured to obtain a plurality of CBs of a first codeword, wherein each CB of the plurality of the CBs is associated with a corresponding set of resource elements, wherein each set of resource elements comprises a plurality of subsets of resource elements, generate a CBB comprising the plurality of the CBs, wherein the CBB is associated with a first ordering of the plurality of the CBs, generate a plurality of CBB cycles associated with the CBB by interleaving, based on the first ordering of the plurality of the CBs, the subsets of the resource elements associated with the plurality of the CBs, apply, to the plurality of the CBB cycles, a staggered resource mapping across a plurality of layers, and transmit, via the plurality of the layers, the plurality of the CB s based on the staggered resource mapping across the plurality of the layers. In certain aspects, the base station 102 may have a CBB-based layer mapping component 199 that may be configured to obtain a plurality of CBs of a first codeword, wherein each CB of the plurality of the CBs is associated with a corresponding set of resource elements, wherein each set of resource elements comprises a plurality of subsets of resource elements, generate a CBB comprising the plurality of the CBs, wherein the CBB is associated with a first ordering of the plurality of the CBs, generate a plurality of CBB cycles associated with the CBB by interleaving, based on the first ordering of the plurality of the CBS, the subsets of the resource elements associated with the plurality of the CBs, apply, to the plurality of the CBB cycles, a staggered resource mapping across a plurality of layers, and transmit, via the plurality of the layers, the plurality of the CBs based on the staggered resource mapping across the plurality of the layers. Although the following description may give examples based on 5G NR to illustrate concepts relating to wireless communication, the concepts described herein may be applicable to other similar areas, such as 6G, and other wireless technologies.

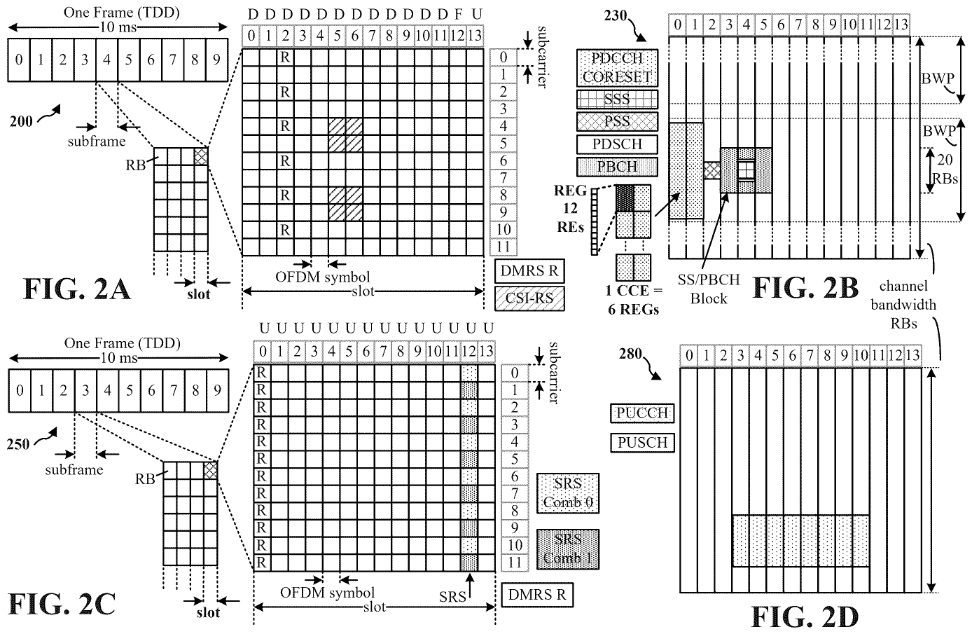

FIG. 2A is a diagram 200 illustrating an example of a first subframe within a frame structure. FIG. 2B is a diagram 230 illustrating an example of DL channels within a subframe. FIG. 2C is a diagram 250 illustrating an example of a second subframe within a frame structure. FIG. 2D is a diagram 280 illustrating an example of UL channels within a subframe. The examples in FIGS. 2A-2D show example aspects of a frame structure based on 5G NR to illustrate the concept of a frame structure and wireless communication based on a frame structure. Various aspects described in connection with FIGS. 2A-2D may also be used in connection with other wireless communication technologies, such as 6G among other examples. The frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. U Es are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PB CH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

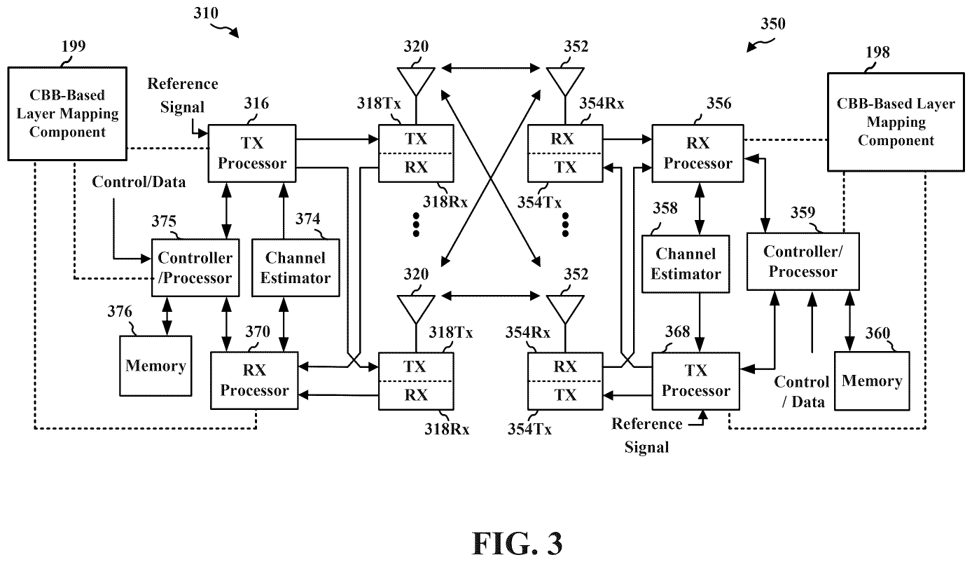

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318T x may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PD Us, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354T x. E ach transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CBB-based layer mapping component 198 of FIG. 1.

At least one of the TX processor 316, the RX processor 370, and the controller/processor 375 may be configured to perform aspects in connection with the CBB-based layer mapping component 199 of FIG. 1.

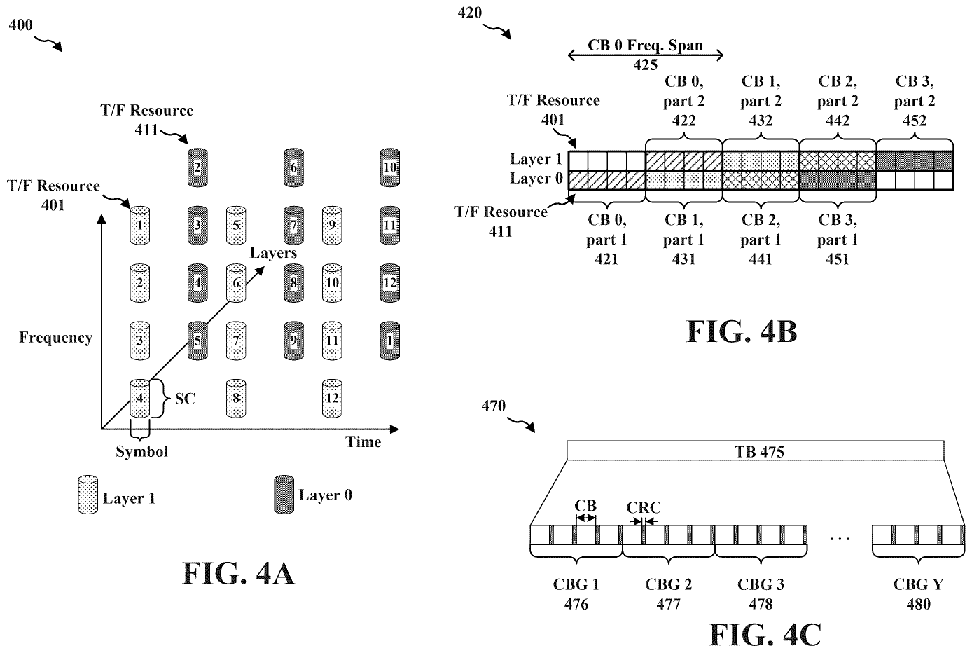

In some aspects of wireless communication, data for transmission may be organized at multiple levels, e.g., a TB may include one or more CB groups (CBGs), each CBG may include one or more CBs. FIG. 4C is a diagram 470 that illustrates a TB 475 and a set of CBs derived from the TB 475. FIG. 4C shows that the set of CBs may include CRC, in some aspects. FIG. 4C shows that the CBs can be grouped into CBGs, e.g., 476, 477, 478, and 480, e.g., for a set of Y CBGs. Additionally, multiple CB s may be combined to produce one or more codewords. A transmitting wireless device may communicate the one or more codewords using a MIMO (or MISO) architecture (or method) such that code blocks of a codeword are mapped to multiple spatial layers (e.g., communicated using various antenna ports or DM RS ports of the wireless device) and/or multiple time-frequency resources. In some aspects, different codewords may be mapped to different respective layers. For example, a wireless device may transmit multiple code blocks of a codeword using a single spatial layer over multiple time-frequency resources (e.g., RBs or REs). In some aspects, a wireless device may map a single codeword to multiple layers (and over multiple time-frequency resources, e.g., RBs or REs). For example, a wireless device operating in a 5G NR system may transmit different code blocks of a single codeword over multiple layers and multiple radio-frequency resources. In some aspects, a wireless device may use multiple spatial layers in a single time-frequency resource to transmit a same code block (e.g., repetitions of a single code block) or different code blocks.

In some aspects, a transmitting wireless device (e.g., a transmitter or transmitting device) may apply a “spatially coupled” coded MIMO (SC-MIMO) as a rate matching feature for multi-layer transmission schemes. The SC-MIMO, in some aspects, may apply a mapping similar to a Bell Labs layered space-time (BLAST) architecture/structure (e.g., a diagonal BLAST or D-BLAST structure). A D-BLAST like layer mapping may, in some aspects, allow each code block in a TB to have non-overlapping footprints in at least one of a frequency domain and a time domain across transmission layers. In some aspects, the SC-MIMO may be viewed as a layer specific (or group of layer-specific) staggering of code blocks in the time and frequency domains (or in a combined time-and-frequency domain) for a transmission. A wireless device receiving an SC-MIMO transmission (e.g., a receiver or receiving device), in some aspects, may perform a decoding and/or detection of the individual code blocks that involves a sequential de-mapping and/or demodulating and decoding on a CB-by-CB basis. In some aspects, one or more code blocks that are easiest to decode (“special CBs”) may be passed through (or processed based on) the demodulation and decoding operations at the receiver. The receiver may then, based on the decoded one or more CBS (e.g., the “special CBs”), subtract the corresponding signal from a received signal (e.g., a raw signal) to facilitate a demodulation and decoding of subsequent code blocks. The iterative, or sequential, demodulation and decoding, in some aspects, may be performed in a manner similar to a “successive cancellation.”

FIG. 4A is a diagram 400 illustrating resources that may be used to transmit a set of CBs based on a SC-MIMO mapping. Diagram 400 illustrates a set of resources in a time-frequency-layer space and/or domain. Each layer may be associated with an indexed or ordered set of time-and-frequency (T/F) resources (e.g., T/F resource 411 associated with a first layer, layer 0, and T/F resource 401 associated with a second layer, layer 1). Each of the indexed time-and-frequency resources, in some aspects, may be an RE (as illustrated for the fourth resource of the second layer, layer 1). In other aspects, each of the indexed time-and-frequency resources may represent a set of time-and-frequency resources (e.g., K REs) used to transmit a portion of a CB. The indexed T/F resources may be presented in subsequent illustrations as a linear set of T/F resources. The decoding may, in some aspects, proceed from the T/F resources having the lowest index to perform the successive cancellation demodulation and/or decoding.

FIG. 4B is a diagram 420 illustrating a mapping of data associated with each CB according to a SC-MIMO implementation. Diagram 420 illustrates that a set of 4 CB s of a codeword may be mapped to two layers for transmission. For purposes of illustration, each CB may be rate matched to 8 RBs (e.g., 8 RBs may be used to carry the CB). In some aspects, the number of RBs associated with the CB (e.g., the number of RBs to which the CB is rate matched) may include one or more repetitions of the CB. Diagram 420 illustrates that each of the time-and-frequency resources (e.g., T/F resource 411 and T/F resource 401) may include 4 RBs such that each CB may be divided between two T/F resources. For example, each of 4 CBs may be divided into two parts (e.g., CB 0 part 1 421, CB 0 part 2 422, CB 1 part 1 431, CB 1 part 2 432, CB 2 part 1 441, CB 2 part 2 442, CB 3 part 1 451, CB 3 part 2 452) where a first part is mapped to the first layer (e.g., layer 0) and a second part is mapped to a second layer (e.g., layer 1).

In some aspects, a larger number of layers (e.g., 4 layers) may be associated with the transmission of the codeword and the T/F resources may include a smaller number of RBs (e.g., 2 RBs) such that the CB is distributed across the larger number of layers. While the discussion above uses the example of R Bs as the base unit (e.g., the smallest considered or allocatable unit) of a time-and-frequency resource, in other aspects, other units such as REs or REGs may be used as the base unit of a time-and-frequency resource. Based on the SC-MIMO implementation depicted in diagram 420, each CB may span two of the T/F resources defined as in diagram 400 corresponding to 8 RBs across the two layers (as opposed to spanning the same 4 RBs in each of the two layers in the absence of the SC-MIMO implementation/mapping). For example, diagram 420 illustrates a frequency span 425 for a first CB that is equal to the number of RBs in the CB and that is assumed to be the same for each CB illustrated in diagram 420.

When using the SC-MIMO with layer-specific rate matching of each CB, the footprint of each CB in a time/frequency domain may be limited to the number of REs (or RBs) to which each CB is rate matched. In some aspects, the transmitter may additionally perform a precoding resource group (PRG) based frequency interleaving to increase a frequency diversity (or expand a frequency span associated with the CB or the RBs to which the CB is mapped) based on the number of PRGs associated with a CB. For a high modulation and coding scheme (MCS) and/or high rank transmission, the number of PRGs making up, included in, or associated with, a CB may be limited. For example, for an 8K bit CB with code rate 0.9 using 256QAM and rank 4 transmission, the CB may occupy approximately 23R Bs or roughly 6 PRGs (assuming PRG size of 4 RBs). For this example, the footprint of a CB may be expanded by a factor of 4×6 (#layers x #PRGs per CB), which in some aspects may not be sufficient to achieve the benefits of frequency diversity. In some aspects, the insufficiency may be especially true when an underlying channel is less selective (e.g., with giga MIMO (gMIMO) beamforming).

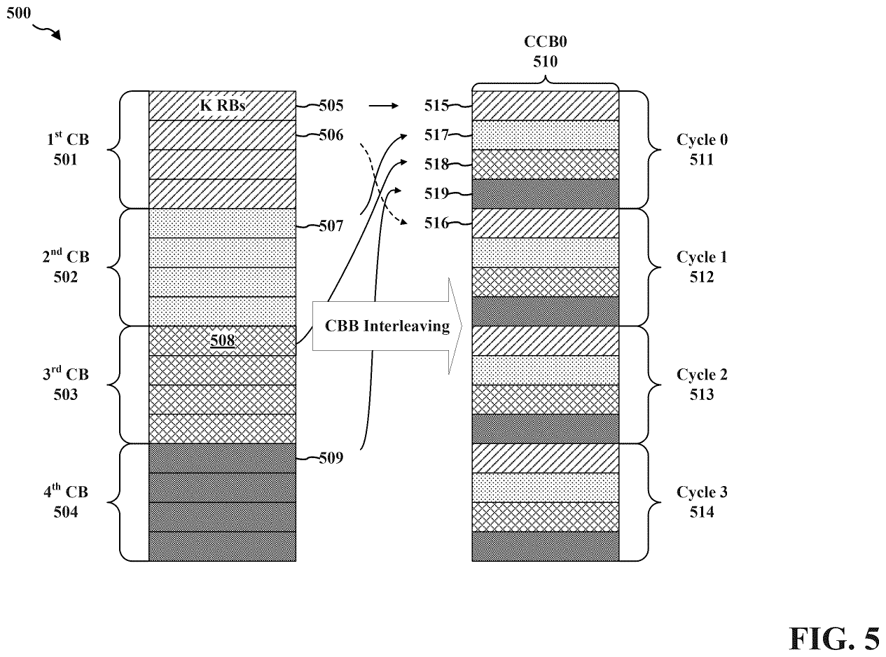

FIG. 5 is a diagram 500 illustrating an example of code block bundling. A CBB (e.g., CBB 510), in some aspects, may include a group of CBs (e.g., including a first CB 501, a second CB 502, a third CB 503, and a fourth CB 504) that are rate matched in a round robin manner (e.g., based on a plurality of round robin steps or operations). The grouping of CBs relating to the CBB, in some aspects, may be unrelated to the CBGs described in FIG. 4C. For example, the CBGs may be defined as part of a hierarchical structure of data associated with a single TB that may be associated with retransmissions. For example, the CBGs may be associated with (or used to achieve) efficient retransmission and/or reduced overhead associated with retransmission. The group of CBs associated with the code block bundling may belong to a same CB G, to different CBGs, or to no CBG and may, for example, be associated with increased frequency diversity. In some aspects, the rate matching may be associated with mapping a fixed, or configurable, part of each CB (e.g., a set of K RBs or resources, such as resources 505, resources 506, resources 507, resources 508, and resources 509) to T/F resources in each round robin step (e.g., to T/F resources 515, T/F resources 516, T/F resources 517, T/F resources 518, and T/F resources 519) to produce a CBB “cycle” (e.g., Cycle 0 511, cycle 1 512, cycle 2 513, and cycle 3 514). As used herein a “cycle” may refer to a set of interleaved resources of the CBB including one set of resources for each CB in, or associated with, the CBB. For example, for a first round robin step, first resources in each CB of the CBB (e.g., resources 505, resources 507, resources 508, and resources 509) may be mapped to the T/F resources (e.g., T/F resources 515, T/F resources 517, T/F resources 518, and T/F resources 519) of a first cycle (e.g., cycle 0 511) of the CBB. The CB footprint of the CBs in the CBB may be expanded (e.g., by a factor equal to the number of CBs in the CBB) compared to a CB footprint without code block bundling. In some aspects, increasing the number of CBs per CBB may increase the frequency diversity gain per CB in the CBB.

For example, diagram 500 illustrates a CBB operation for a set of 4 CB s each spanning 4 sets of K resources being mapped to cycles of a CBB. In some aspects, modulated symbols corresponding to a set of K resources (e.g., such as resources 505 which may span K RBs) from each CB are rate matched to a corresponding set of K resources (e.g., K RBs) in a cycle during each round robin step For each round robin step the mapping may cycle through the 4 CBs in the CBB in a fixed order to produce a cycle of the CBB. The number of cycles per CBB is ceiling (CB size in number of REs/K), where K is the number of frequency resources (or T/F resources) each CB gets rate matched to in each round robin step. For example, in diagram 500, if K is assumed to be 4 RBs (and each CB includes, or spans, 16 RBs), then, for a K equal to 2 RBs, there would be 8 cycles. Similarly for K equal to 1 RB or 6 REs, there would be 16 or 32 cycles, respectively. In some aspects, the value for K may be a known (preconfigured) or configured value. Compared to the baseline approach, each CB gets spread over a number of disjoint clusters in a frequency domain that is at least equal to the number of REs and/or RBs in a CB divided by the number of REs and/or RBs, K, in a T/F resource in the cycle (a T/F resource mapped to a single CB).

Various aspects relate generally to the introduction of frequency interleaving based on CBB to a staggered SC-MIMO. In some aspects, introducing frequency diversity by interleaving CBs in a CBB may increase a rate loss based on the larger size of a CBB unit and corresponding set of empty resources to allow for a decoding of a first CBB unit. Some aspects more specifically relate to methods to reduce rate loss by manipulating a staggering method (or introducing a modified staggering method) such that, instead of having empty resources corresponding to a full CBB, the empty resources correspond to a subset of the CB s in the CBB. In some examples, a wireless device (transmitter) may be configured to obtain a plurality of CBs of a first codeword, wherein each CB of the plurality of the CBs is associated with a corresponding set of resource elements, wherein each set of resource elements comprises a plurality of subsets of resource elements, generate a CBB comprising the plurality of the CBs, wherein the CBB is associated with a first ordering of the plurality of the CBs, generate a plurality of CBB cycles associated with the CBB by interleaving, based on the first ordering of the plurality of the CBs, the subsets of the resource elements associated with the plurality of the CBs, apply, to the plurality of the CBB cycles, a staggered resource mapping across a plurality of layers, and transmit, via the plurality of the layers, the plurality of the CB s based on the staggered resource mapping across the plurality of the layers.

Particular aspects of the subject matter described in this disclosure can be implemented to realize one or more of the following potential advantages. In some examples, by introducing frequency diversity by interleaving CBs in a code block bundle using the modified staggering method, the described techniques can be used to improve the frequency diversity for a CB while maintaining a rate loss associated with the unmodified staggering method.

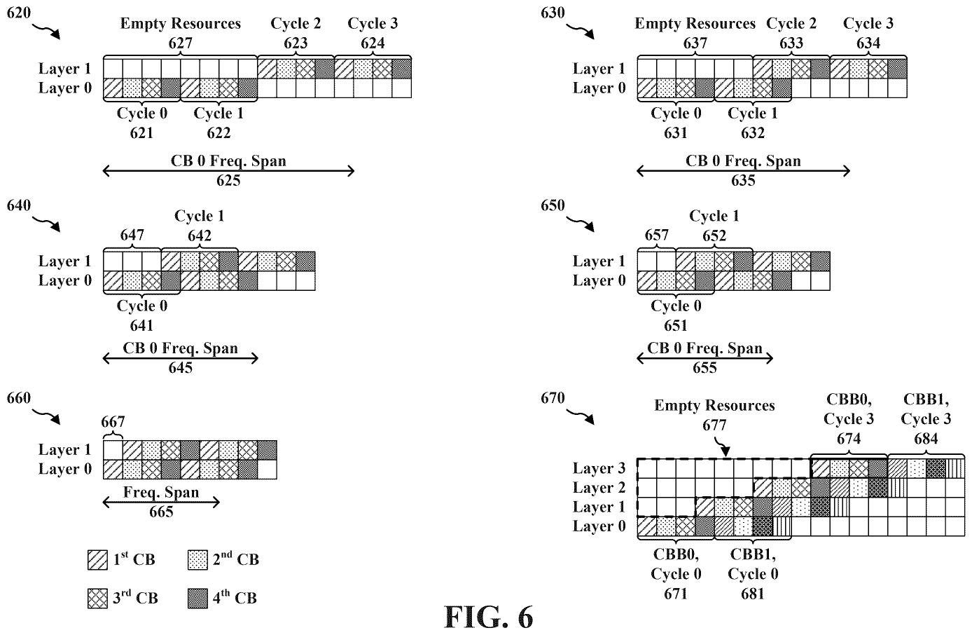

FIG. 6 is a set of diagrams (diagram 620, diagram 630, diagram 640, diagram 650, diagram 660, and diagram 670) illustrating different implementations of a CBB-based layer mapping (e.g., a CBB-based SC-MIMO or CBB-based staggered layer mapping). As discussed in relation to a baseline SC-MIMO illustrated in diagram 420 a CBB interleaving may be applied in addition to SC-MIMO coupling across spatial layers and PRG interleaving. Accordingly, the CBB interleaving (in the CBB-based staggered layer mapping) may increase the number of resource clusters (and a corresponding frequency diversity/span of the resources) to which a CB over a non-SC-MIMO is mapped by a factor based on the number of layers “L” associated with the SC-MIMO, a number of PRGs “P” per CB, and a number of CBS “

$${N}_{CB}^{CBB}$$

” in a CBB (e.g., an increase by a factor up to

$$L \times P \times {N}_{CB}^{CBB}$$

or an increase by a factor

$${N}_{CB}^{CBB}$$

over the baseline SC-MIMO)). In some aspects, as discussed below in relation to diagram 630, diagram 640, diagram 650, diagram 660, and diagram 670, reducing a number of resources corresponding to a first set of T/F resources for a first CB that are left empty to allow for decoding of the transmission via the first set of T/F resources without interference may be associated with a reduced rate loss at the cost of a reduced additional frequency diversity.

Diagram 620 illustrates a first application and/or implementation of CBB-based staggered layer mapping (e.g., a SC-MIMO layer mapping applied to each code block bundle or group of interleaved code blocks instead of individual code blocks). The CBB-based staggered layer mapping may be associated with a mapping of the cycles of the CBB (e.g., a first cycle 621, a second cycle 622, a third cycle 623, or a fourth cycle 624) to the T/F resources in the different layers. The first application and/or implementation of the CBB-based staggered layer mapping illustrated in diagram 620, in some aspects, may achieve additional frequency diversity gain (e.g., an increased frequency span) when compared to a baseline SC-MIMO (e.g., the baseline SC-MIMO illustrated in diagram 420). For example, when using the SC-MIMO of diagram 420, the frequency span (e.g., corresponding to the frequency span 425) for a CB including 4 RBs may be 4 RBs while the frequency span 625 for a first CB including 4 RBs (e.g., assuming, for diagram 620, a T/F resource unit is equal to 1 RB, or K=1 RB, and there are 4 CBs per CBB mapped across 2 layers) may be 13 RBs. In general, for

$${N}_{CB}^{CBB}$$

### CDS per CBD,

$${N}_{Cyc}^{CBB}$$

of CBB cycles per CBB, where each CBB cycle includes K T/F resources from each CB and a CB includes

$$K \times {N}_{CB}^{CBB} T / F$$

resources, a number of layers L, and an offset M specified in a number of empty T/F resources between a first resource used in a first layer and a first resource used in a second (adjacent) layer (e.g., a number of empty resources in a set of empty resources 627), a frequency diversity/span (Fₛₚₐₙ) may be determined based on Fₛₚₐₙ=

$$( K \times {N}_{CB}^{CBB} ) \times ( \frac{{N}_{CB}^{CBB}}{L} - 1 ) + 1 + M \times ( L - 1 ) . The {F}_{span} ,$$

in some aspects, may be expressed in the units used to specify/define K, such as one of REs, RBs, or T/F resources.

As illustrated in diagram 620, a bundling of the CBs may be associated with an inherent rate loss when CB bundles are staggered across layers and special, or blank/empty, CBs (or T/F resources) are incorporated to kickstart the SIC process (e.g., empty resources 637 provided as an interference-free T/F resource to allow a first demodulation associated with the SIC process). Accordingly, increasing the number of CBs in a CBB, may increase the frequency gain from CB interleaving (based on the span of the cycles associated with the CB bundling) but may also increase the rate loss due to the corresponding empty resources is also higher. In some aspects, a network may be able to minimize the effect of staggering (e.g., the rate loss based on empty resources associated with the staggering). For example, different offsets associated with per-layer staggering may be configured for the CBB-based staggered layer mapping to optimize a tradeoff between the interleaving gain and the rate loss due to layer-staggering.

Diagram 630 illustrates an additional application and/or implementation of CBB-based staggered layer mapping (e.g., a (SC-MIMO) layer mapping applied to each code block bundle or group of interleaved code blocks instead of individual code blocks) with a first offset (e.g., M=6 T/F resources, where non-overlapping resources correspond to an offset of

$$M = 8 , or ( K \times {N}_{CB}^{CBB} ) \times ( \frac{{N}_{Cyc}^{CBB}}{L} ) ) .$$

The CBB-based staggered layer mapping may be associated with a mapping of the cycles of the CBB (e.g., a first cycle 631, a second cycle 632, a third cycle 633, or a fourth cycle 634) to the T/F resources in the different layers. The additional application and/or implementation of the CBB-based staggered layer mapping illustrated in diagram 630, in some aspects, may achieve additional frequency diversity gain (e.g., an increased frequency span) when compared to a baseline SC-MIMO (e.g., the baseline SC-MIMO illustrated in diagram 420). However, the additional application and/or implementation of the CBB-based staggered layer mapping illustrated in diagram 630, in some aspects, may achieve a reduced frequency diversity gain when compared to the CBB-based staggered layer mapping using an offset value closer to 0 (e.g., the CBB-based staggered layer mapping illustrated in diagram 620). For example, for the offset value (e.g., e.g., M=6 T/F resources) illustrated in diagram 630, the frequency span 635 for a first CB including 4 RBs (e.g., assuming a T/F resource unit or K is equal to 1 RB for diagram 630 and there are 4 CBs per CBB) may be 11 RBs (e.g.,

$$( K \times {N}_{CB}^{CBB} ) \times ( \frac{{N}_{CB}^{CBB}}{L} - 1 ) + 1 + M \times ( L - 1 ) = ( 1 \times 4 ) \times ( 2 - 1 ) + 1 + 6 \times ( 2 - 1 ) = 11 RBs ) .$$

Accordingly, the number of T/F resources associated with both the rate loss due to empty resources 637 and the frequency span may be decreased by decreasing the offset, M.

Diagram 640 illustrates an additional application and/or implementation of CBB-based staggered layer mapping (e.g., a SC-MIMO layer mapping applied to each code block bundle or group of interleaved code blocks instead of individual code blocks) with a first offset (e.g., M=3 T/F resources). The CBB-based staggered layer mapping may be associated with a mapping of the cycles of the CBB (e.g., a first cycle 641, a second cycle 642, a third cycle, or a fourth cycle) to the T/F resources in the different layers. The additional application and/or implementation of the CBB-based staggered layer mapping illustrated in diagram 640, in some aspects, may achieve additional frequency diversity gain (e.g., an increased frequency span) when compared to a baseline SC-MIMO (e.g., the baseline SC-MIMO illustrated in diagram 420). However, the additional application and/or implementation of the CBB-based staggered layer mapping illustrated in diagram 640, in some aspects, may achieve a reduced frequency diversity gain when compared to the CBB-based staggered layer mapping using an offset value closer to 0 (e.g., the CBB-based staggered layer mapping illustrated in diagram 620). For example, for the offset value (e.g., e.g., M=3 T/F resources) illustrated in diagram 640, the frequency span 645 for a first CB including 4 RBs (e.g., assuming a T/F resource unit or K is equal to 1 RB for diagram 640 and there are 4 CBs per CBB) may be 8 RBs. Accordingly, the number of T/F resources associated with both the rate loss due to empty resources 647 and the frequency span may be decreased by decreasing the offset, M.

Diagram 650 illustrates an additional application and/or implementation of CBB-based staggered layer mapping (e.g., a SC-MIMO layer mapping applied to each code block bundle or group of interleaved code blocks instead of individual code blocks) with a first offset (e.g., M=2 T/F resources). The CBB-based staggered layer mapping may be associated with a mapping of the cycles of the CBB (e.g., a first cycle 651, a second cycle 652, a third cycle, or a fourth cycle) to the T/F resources in the different layers. The additional application and/or implementation of the CBB-based staggered layer mapping illustrated in diagram 650, in some aspects, may achieve additional frequency diversity gain (e.g., an increased frequency span) when compared to a baseline SC-MIMO (e.g., the baseline SC-MIMO illustrated in diagram 420). However, the additional application and/or implementation of the CBB-based staggered layer mapping illustrated in diagram 650, in some aspects, may achieve a reduced frequency diversity gain when compared to the CBB-based staggered layer mapping using an offset value closer to 0 (e.g., the CBB-based staggered layer mapping illustrated in diagram 620). For example, for the offset value (e.g., e.g., M=2 T/F resources) illustrated in diagram 650, the frequency span 655 for a first CB including 4 RBs (e.g., assuming a T/F resource unit or K is equal to 1 RB for diagram 650 and there are 4 CBs per CBB) may be 7 RBs. Accordingly, the number of T/F resources associated with both the rate loss due to empty resources 657 and the frequency span may be decreased by decreasing the offset, M.

Diagram 660 illustrates an additional application and/or implementation of CBB-based staggered layer mapping (e.g., a SC-MIMO layer mapping applied to each code block bundle or group of interleaved code blocks instead of individual code blocks) with a first offset (e.g., M=1 T/F resource). The CBB-based staggered layer mapping may be associated with a mapping of the cycles of the CBB (e.g., a first cycle, a second cycle, a third cycle, or a fourth cycle) to the T/F resources in the different layers. The additional application and/or implementation of the CBB-based staggered layer mapping illustrated in diagram 660, in some aspects, may achieve additional frequency diversity gain (e.g., an increased frequency span) when compared to a baseline SC-MIMO (e.g., the baseline SC-MIMO illustrated in diagram 420). However, the additional application and/or implementation of the CBB-based staggered layer mapping illustrated in diagram 660, in some aspects, may achieve a reduced frequency diversity gain when compared to the CBB-based staggered layer mapping using an offset value closer to 0 (e.g., the CBB-based staggered layer mapping illustrated in diagram 620). For example, for the offset value (e.g., e.g., M=1 T/F resource) illustrated in diagram 660, the frequency span 665 for a first CB including 4 RBs (e.g., assuming a T/F resource unit or K is equal to 1 RB for diagram 660 and there are 4 CBs per CBB) may be 6 RBs. Accordingly, the number of T/F resources associated with both the rate loss due to empty resources 667 and the frequency span may be decreased by decreasing the offset, M.

In some aspects, a transmitter may (e.g., based on determining, or being configured, to) use a particular value for M. As described above, the values for M may be defined and/or specified based on the number of empty (T/F) resources between a first T/F resource mapped to a CB (or CBB cycle) in an adjacent layer and a first T/F resource mapped to a CB (or CBB cycle) in a current layer. The values for M, in some aspects, may be subject to one or more conditions such as (1) that the number of empty resources associated with the value for M is an integer multiple of the number of resources in a CBB cycle associated with a single CB (e.g., K REs resources which may be a single T/F resource for the CBB-based staggered layer mapping), (2) that the number of empty resources associated with the value for M is less than a number of resources associated with a single CBB cycle (e.g.,

$$K \times {N}_{CB}^{CBB}$$

resources), (3) that the number of empty resources associated with the value for M is not an integer multiple of the number of resources associated with a single CBB cycle (e.g.,

$$K \times {N}_{CB}^{CBB}$$

and/or (4) that the number of empty resources associated with the value for M is no greater than the number of T/F resources associated with a cycle of the CBB multiplied by the number of cycles mapped to each layer (e.g.,

$$M \leq K \times {N}_{CB}^{CBB} \times ( \frac{{N}_{Cyc}^{CBB}}{L} )$$

In some aspects, if the value of M is provided in a unit that is smaller than the size of a T/F resource for the CBB-based staggered layer mapping mapping, the allowed values of M may further be subject to the conditions that M is an integer multiple of the number of resources associated with a T/F resource (e.g., the size of the T/F resource).

Diagram 670 illustrates an additional application and/or implementation of CBB-based staggered layer mapping (e.g., a SC-MIMO layer mapping applied to each code block bundle or group of interleaved code blocks instead of individual code blocks) with a first offset (e.g., M=3 T/F resources) for a set of 4 layers and illustrates cycles of an additional CBB (e.g., a first cycle 681 of the CBB1). The CBB-based staggered layer mapping may be associated with a mapping of the cycles of the CBBs (e.g., a first cycle 671, a second cycle, a third cycle, and a fourth cycle 674 of the first CBB and a first cycle 681, a second cycle, a third cycle, and a fourth cycle 684 of a second CBB) to the T/F resources in the different layers. While illustrated for a number of cycles equal to the number of layers, a CBB with additional cycles may be mapped as in diagram 640, diagram 650, or diagram 660. The additional application and/or implementation of the CBB-based staggered layer mapping illustrated in diagram 670, in some aspects, may achieve additional frequency diversity gain (e.g., an increased frequency span) when compared to a baseline SC-MIMO (e.g., the baseline SC-MIMO illustrated in diagram 420). For example, for the offset value (e.g., e.g., M=3 T/F resources) illustrated in diagram 670, the frequency span for a first CB including 4 RBs (e.g., assuming a T/F resource unit or K is equal to 1 RB for diagram 670 and

there are 4 CBs per CBB) may be 10 RBs (e.g.,

$$( K \times {N}_{CB}^{CBB} ) \times ( \frac{{N}_{CB}^{CBB}}{L} - 1 ) + 1 + M \times ( L - 1 ) = ( 1 \times 4 ) \times ( \frac{4}{4} - 1 ) + 1 + 3 \times ( 4 - 1 ) = 10 RBs ) .$$

In some aspects, the number of T/F resources associated with both the rate loss due to empty resources 677 and the frequency span may be decreased by decreasing the offset, M (and the term M×(L−1), where the term (L−1) accounts for the shift of each layer relative to an adjacent layer that “compounds” as the number of layers increases.

For example, for the examples in diagram 640, diagram 650, and diagram 660, the offsets may be equal to 1, 2, or 3 times the number of resources (e.g., K REs/RBs) associated with a particular CB in a single cycle (e.g., M=K, 2K, 3K REs/RBs or M=1, 2, 3 T/F resources). In some aspects, the offset may not be equal to

$${N}_{CB}^{CBB}$$

times the number of resources (e.g., K REs/R Bs) associated with a particular CB in a single cycle as it would cause an overlap of REs/RBs of a same CB (e.g., non-cancellable transmissions using the SIC). In diagram 660, for M=1, 25% of the REs associated with a first CB, and 50% of the REs associated with the rest of the CBs (in the CBB), may be associated with a demodulation based on a canceled interference (or no interference). Similarly, in diagram 650, M=2, 25% of the REs associated with the first and second CBs, and 75% of the REs associated with the third and fourth CBS (in the CBB), may be associated with a demodulation based on a canceled interference (or no interference). In diagram 640, for M=3, 25% of the REs associated with the first CB, 50% of the REs associated with the second and third CBS, and 75% of the REs associated with the fourth CB (in the CBB), may be associated with a demodulation based on a canceled interference (or no interference). A RE or, more generally, a T/F resource, that can be demodulated based on a canceled (or lack of) interference may be referred to as an interference-free RE (or T/F resource) or as being free of interference.

For example, if first resource elements of the first CB in a CBB cycle (e.g., a set of K REs of the CB that are included in a single CBB cycle) are transmitted via first time-and-frequency resources associated with a first layer, the first resource elements may be (or may be referred to as) free of the interference if one of (1) the first time-and-frequency resources associated with a different layer of the plurality of layers are not used to transmit other resource elements associated with a different CB in the plurality of CBs, or (2) additional resource elements that are transmitted via the first time-and-frequency resources associated with one or more of the different layers of the plurality of layers, are associated with one or more CBs in the plurality of CBs that are able to be canceled in association with a successive cancellation decoding before decoding the first CB. Referring to diagram 660, for example, the first set of REs of the first CB are transmitted in a first T/F resource in a first layer (e.g., layer 0) and no REs of any code block are transmitted in a corresponding first T/F resource in a second layer (e.g., layer 1). Accordingly, the first set of REs of the first CB are interference-free. In contrast, a second set of REs of the first CB are transmitted in a second T/F resource in the second layer and a first set of REs of the second CB are transmitted in a corresponding second T/F resource of the first layer, where the first set of REs of the second CB are not cancelable when demodulating the first DB (e.g., assuming the CBs are demodulated in order of reception) and the second set of REs of the first CB are not interference free. The first set of REs of the second CB, despite being transmitted in T/F resources corresponding to the T/F resources used to transmit the second set of REs of the first CB, in some aspects, may be interference-free based on the ability to “cancel” (e.g., remove or subtract) the interference from the second set of REs of the first CB. While diagram 640, diagram 650, and diagram 660 illustrate a layer mapping for a single CBB cycle, additional cycles may be mapped similarly (e.g., as a “space filling” tiling as for the first cycle 671 of the first CBB and the first cycle 681 of the second CBB in diagram 670) such that although it appears that the last set of REs of the fourth CB experience no interference, they would in fact experience interference from a first set of REs from a first CB of a second and/or subsequent/adjacent CBB cycle.

As described in relation to diagram 640, diagram 650, and diagram 660, configuring different offsets for per-layer staggering may lead to an overall imbalance in CB demodulation performances due to different CBs experiencing/receiving the benefit of SIC for different fractions of the REs in the CB. For example, when using M=1, 2, 3 T/F resource, the percentage of the REs not experiencing interference either due to benefitting from SIC or alignment with an empty/blank RE (generally referred to as interference-free REs) for a first CB, a second CB, a third CB, and a fourth CB may be {25%, 50%, 50%, 75%}, {25%, 25%, 75%, 75%}, and {25%, 50%, 50%, 75%}, respectively. Even though using M=2 and M=3 yield the same total percentage of CBs in a CBB that have a no-interference demodulation (e.g., benefit from the SIC), using M=3 may be better in terms of uniformity of CB performance. In general, the number of allowable offset values and distributions/combinations of no-interference demodulation percentages may increase with bigger CBB size, leading to more offset values and/or combinations with a CB demodulation imbalance.

In some aspects, for a given CBB size and staggering offset per layer, the demodulation performance imbalance may be mitigated by one or more of transmitting CBs with a transmission power and/or MCS based on the percentage of interference-free REs for the CB. For example, CBs may be transmitted with a transmission power inversely proportional to the ratio of the affected REs (e.g., CBs with a smaller percentage and/or share of interference-free REs will be transmitted with higher power) and/or CBs may be transmitted with a modulation order and or coding rate (e.g., a lower MCS) proportional to the ratio of the affected REs (e.g., CBs with a smaller percentage and/or share of interference-free REs will be transmitted using a lower MCS).

For example, a relative demodulation performance of CBs in a bundle of N CBs can be expressed as {x₀, x₁, x₂, . . . x_{N-1}}, where xᵢ is the fraction of REs rate matched to the i^{th} CB that are subjected to interference-free demodulation. Then, the transmit power or the MCS of the CBs can be chosen for the CBs based on a range in which the fraction xᵢ falls (e.g., where a plurality of endpoints, {X₀, X₁, X₂, . . . . X_{J-1}}, defining J+1 (or J−1 if X₀=0 and X_{J-1}=1) different ranges each associated with a different MCS, transmission, or combination of MCS and transmission power may be configured or known and used to determine the MCS and/or transmission power for each of the CBs)

For instance, x₁ and x₃ corresponding to the first and third CBs in case of M=2 in diagram 650 may be ¼ and ¾, respectively. A transmitter, based on the xᵢ values, may determine to use and/or may select a corresponding transmit power Pᵢ that is inversely proportional, or inversely related to the, x; (e.g., a transmit power Pᵢ increases with decreasing values of xᵢ). For example, a transmission power, may be based on xᵢ falling in a range of Xₗ₋₁≤xᵢ<Xₗ associated with a particular transmission power, Pₗ, with a higher power being associated with a lower range. Similarly, a transmitter, based on the xᵢ values, may determine to use and/or may select a corresponding MCS of the i^{th} CB based on a set of thresholds Xₖ (or threshold endpoints, {X₀, X₁, X₂, . . . . X_{J-1}}, defining J+1 (or J−1 if X₀=0 and X_{J-1}=1) different ranges each associated with a different MCS). For example, the transmitter may determine to use and/or may select MCS0 if xᵢ<X₀, MCS1 if X₀≤xᵢ<X₁, MCS2 if X₁≤xᵢ<X₂ and so on, where MCS0<MCS1<MCS2< . . . so on, and X₀, X₁, X₂, . . . are all fractions. In some aspects, a transmitter that is a wireless device such as a UE may be preconfigured with known values for, or configured with values for, {MCS0, MCS1, MCS2, . . . } and {X₀, X₁, X₂, . . . }, e.g., through RRC messaging.

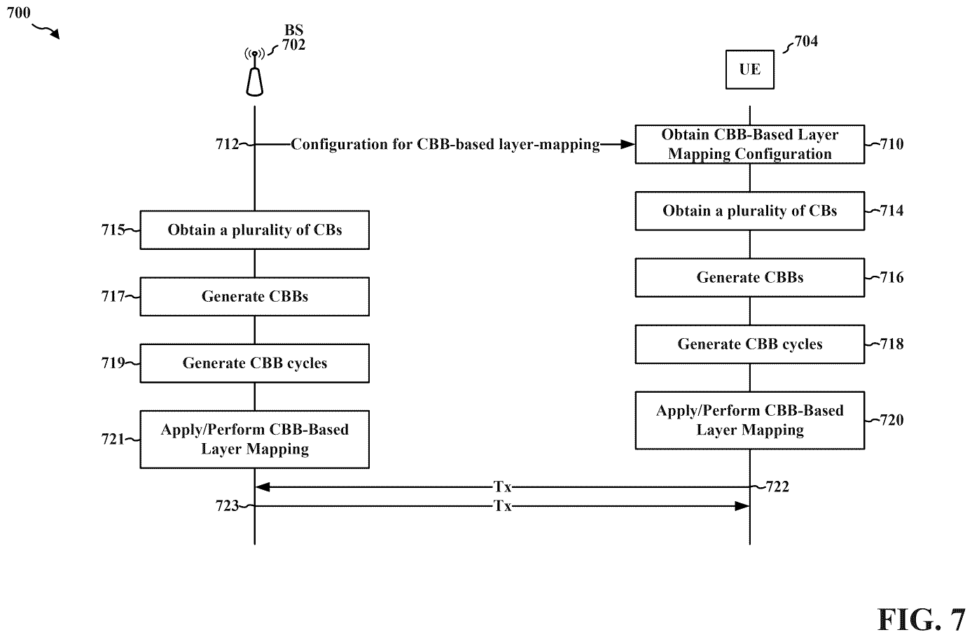

FIG. 7 is a call flow diagram 700 illustrating a method of wireless communication in accordance with some aspects of the disclosure. The method is illustrated in relation to a base station 702 (e.g., as an example of a network device or network node that may include one or more components of a disaggregated base station) in communication with a UE 704 (e.g., as an example of a wireless device). The functions ascribed to the base station 702, in some aspects, may be performed by one or more components of a network entity, a network node, or a network device (a single network entity/node/device or a disaggregated network entity/node/device as described above in relation to FIG. 1). Similarly, the functions ascribed to the UE 704, in some aspects, may be performed by one or more components of a wireless device supporting communication with a network entity/node/device. Accordingly, references to “transmitting” in the description below may be understood to refer to a first component of the base station 702 (or the UE 704) outputting (or providing) an indication of the content of the transmission to be transmitted by a different component of the base station 702 (or the UE 704). Similarly, references to “receiving” in the description below may be understood to refer to a first component of the base station 702 (or the UE 704) receiving a transmitted signal and outputting (or providing) the received signal (or information based on the received signal) to a different component of the base station 702 (or the UE 704). FIG. 7 illustrates both a UE and a base station acting as a transmitter and as a receiver, in other aspects, one of the UE or the base station may be the transmitter.

At 710, the UE 704 may obtain a CBB-based layer mapping configuration. The CBB-based layer mapping, in some aspects, may indicate one or more of (1) a first number of resource elements (e.g., K REs) from each CB that are mapped to a CBB cycle, (2) a set of candidate M CSs for a CB and a corresponding set of disjoint ranges of a fraction of the REs of the CB that are interference-free (e.g., that are received free of interference or for which interference can be canceled), (3) a relationship between a transmission power for a CB and the fraction of the REs of the CB that are interference-free (e.g., Pᵢ=f(xᵢ), such that a transmit power Pᵢ increases with decreasing values of xᵢ). Obtaining the CBB-based layer mapping configuration at 710, in some aspects, may include being preconfigured with the CBB-based layer mapping configuration. In some aspects, obtaining the CBB-based layer mapping at 710 may include, a network device such as base station 702 transmitting, and UE 704 receiving, the CBB-based layer mapping configuration 712. The CBB-based layer mapping configuration 712 may be transmitted/received via RRC signaling and/or an RRC message. In some aspects, the CBB-based layer mapping configuration 712 may be based on the base station 702 obtaining the CBB-based layer mapping configuration, e.g., from a network or by determining the CBB-based layer mapping configuration.

In some aspects, the first number of resource elements (e.g., K REs) from each CB that are mapped to a CBB cycle as well as other parameters and/or characteristics of a CBB may be received in RRC signaling (or information elements (IEs) included in RRC signaling) that is not specific to the CBB-based layer mapping configuration but that may be incorporated and/or used to generate CBBs and/or CBB cycles for multiple operations including the CBB-based layer mapping. For example, a number of REs in a CB and/or a number of CBs included in a CBB may be indicated in one or more IEs not specifically associated with the CBB-based layer mapping configuration (e.g., associated with CBB generally) that may then be used for the CBB-based layer mapping.

At 714, the UE 704 may obtain a plurality of CBs of a codeword for transmission based on the CBB-based layer mapping. The plurality of CBs for the following discussion is assumed to be a first plurality of CBs included in, or making up, a first CBB (i.e., the first plurality of CBs includes the number of CBs per CBB). For example, referring to FIG. 5, the UE 704 may obtain a first CB 501, a second CB 502, a third CB 503, and a fourth CB 504 associated with a CBB 510. In some aspects, each set of resource elements may include a plurality of subsets of resource elements (e.g., resources 505, resources 506, resources 507, resources 508, and resources 509) Additional pluralities of CBs for the codeword and/or one or more additional codewords may be similarly obtained for transmission and may be similarly processed as will be described below for the (first) plurality of CBs. Each codeword may be spread across either a same, or different, number of layers as for normal multiple-input (MI) operation. Independently, the base station 702, when acting as a transmitting device or transmitter, may, at 715, obtain a plurality of CBs of a codeword for transmission based on the CBB-based layer mapping as described in relation to the UE 704 obtaining the plurality of CBs at 714.

The UE 704, may, at 716, generate a CBB including the plurality of the CBs obtained at 714. The CBB, in some aspects, may be associated with a first ordering of the plurality of the CBs (e.g., based on an indexing of the CBs within a TB). For example, a CBB including four CBs may be generated as in FIG. 5 based on an ordering of a first CB 501, a second CB 502, a third CB 503, and a fourth CB 504. Independently, the base station 702, when acting as a transmitting device or transmitter, may, at 717, generate a CBB including the plurality of the CBs obtained (e.g., at 715) as described in relation to the UE 704 generating, at 716, the CBB including the plurality of the CBs obtained at 714.

At 718, the UE 704 may generate a plurality of CBB cycles associated with the CBB by interleaving, based on the first ordering of the plurality of the CBs, the subsets of the resource elements associated with the plurality of the CBs. For example, for a plurality of CBs that includes four CBs as in FIG. 5, four CBB cycles may be generated by interleaving subsets of resources from each of the CBs based on the ordering of the CBs in the CBB (e.g., resources 505, resources 507, resources 508, and resources 509 corresponding to T/F resources 515, T/F resources 517, T/F resources 518, and T/F resources 519 of the first cycle of the CBB 510). A greater number of CBB cycles may be produced by decreasing the number of REs in, or the size of, the interleaved subsets of the resources. For example, if a CB includes, or is associated with, 24 REs four CBB cycles may be generated when using a subset of the resource elements that includes six REs, while 12 cycles may be generated when using a subset of the resource elements that includes two REs.

The interleaving, in some aspects, may be based on a round robin operation in which, starting from a first subset of K REs in a first CB according to the ordering, a subset of K REs (e.g., a subset of the REs associated with the CB, where K is a configured value for the size of the subset of the REs) is selected from/for each CB in turn to make a first cycle. Additional cycles are generated by using the next available set of REs from/for each of the CBs until the last subset of resources from/for a last CB is included in and/or selected for a CBB cycle. Independently, the base station 702, when acting as a transmitting device or transmitter, may, at 719, generate a plurality of CBB cycles associated with the CBB by interleaving, based on the first ordering of the plurality of the CBs, the subsets of the resource elements associated with the plurality of the CBs as described in relation to the UE 704 generating, at 718, the plurality of CBB cycles associated with the CBB.

At 720, the UE 704 may apply, to the plurality of the CBB cycles, a staggered resource mapping across a plurality of layers (e.g., the CBB-based staggered layer mapping illustrated in any of diagram 620, diagram 630, diagram 640, diagram 650, diagram 660, or diagram 670 of FIG. 6). In some aspects, applying the staggered resource mapping may be based on an offset between a (beginning of a) first set of time-and-frequency resources (e.g., T/F resources) used to transmit a first CBB cycle and a (beginning of a) second set of time-and-frequency resources used to transmit a second CBB cycle. The offset, in some aspects, may be configured (e.g., based on CBB-based layer mapping configuration 712 or based on a known, or preconfigured, CBB-based layer mapping configuration) to be an integer multiple of a first number of resource elements (e.g., K REs corresponding to the REs in a CBB cycle that are associated with a single CB). In some aspects, the offset may be less than a second number of resource elements associated with a single CBB cycle (e.g., as in diagram 640, diagram 650, or diagram 660). The second number of resource elements, in some aspects may be a number of REs in a single CBB cycle, e.g.,

$$K \times {N}_{CB}^{CBB} .$$

In some aspects, the offset and a number of CB s in the CBB may be used to determine, for each CB, a fraction of the REs that are interference-free. The fraction of the interference-free REs (or T/F resources), in some aspects, may be used to determine a transmission power associated and/or MCS associated with the transmission of each CB (e.g., for each CB independently based on a corresponding fraction of interference-free resources) based on a function of the fraction (for Tx power) or a set of candidate values based on a range into which the fraction falls (for Tx power or MCS) as discussed above in relation to diagram 640, diagram 650, and diagram 660 of FIG. 6. In some aspects, the determination of the fraction of interference-free resources and related determination of the transmission power and MCS associated with the transmission of the CB may be part of applying the staggered resource mapping across the plurality of layers (e.g., the CBB-based staggered layer mapping) at 720.

In some aspects, the determination of the fraction of interference-free resources and related determination of the transmission power and MCS associated with the transmission of each CB, in some aspects, may be performed, after the application of the staggered resource mapping across the plurality of layers at 720, as part of a transmission of the plurality of CBs based on the application of the staggered resource mapping across the plurality of layers at 720. Independently, the base station 702, when acting as a transmitting device or transmitter, may, at 721, apply, to the plurality of the CBB cycles, a staggered resource mapping across a plurality of layers (e.g., the CBB-based staggered layer mapping illustrated in any of diagram 620, diagram 630, diagram 640, diagram 650, diagram 660, or diagram 670 of FIG. 6) as described in relation to the UE 704 applying the staggered resource mapping across the plurality of layers to the plurality of the CBB cycles at 720.

After the determination of the fraction of interference-free resources and related determination of the transmission power and MCS associated with the transmission of each CB, the UE 704 may transmit, and the base station 702 (as an example of a receiving device) may receive, transmission 722 based on the staggered resource mapping across the plurality of layers applied at 720 and the transmission power and/or MCS determined for the plurality of CBs. In some aspects, transmitting the transmission 722 may include transmitting a first CBB cycle of the plurality of CBB cycles via a first set of time-and-frequency resources associated with a first layer and transmitting a second CBB cycle of the plurality of CBB cycles via a second set of time-and-frequency resources associated with a second layer (as described in the application of the staggered resource mapping across the plurality of layers at 720). As described above, an offset between the first set of time-and-frequency resources and the second set of time-and-frequency resources may be an integer multiple of the first number of resource elements, wherein the offset is less than the second number of resource elements. Independently, the base station 702, when acting as a transmitting device or transmitter, may transmit a transmission 723 as described in relation to the UE 704 transmitting the transmission 722.

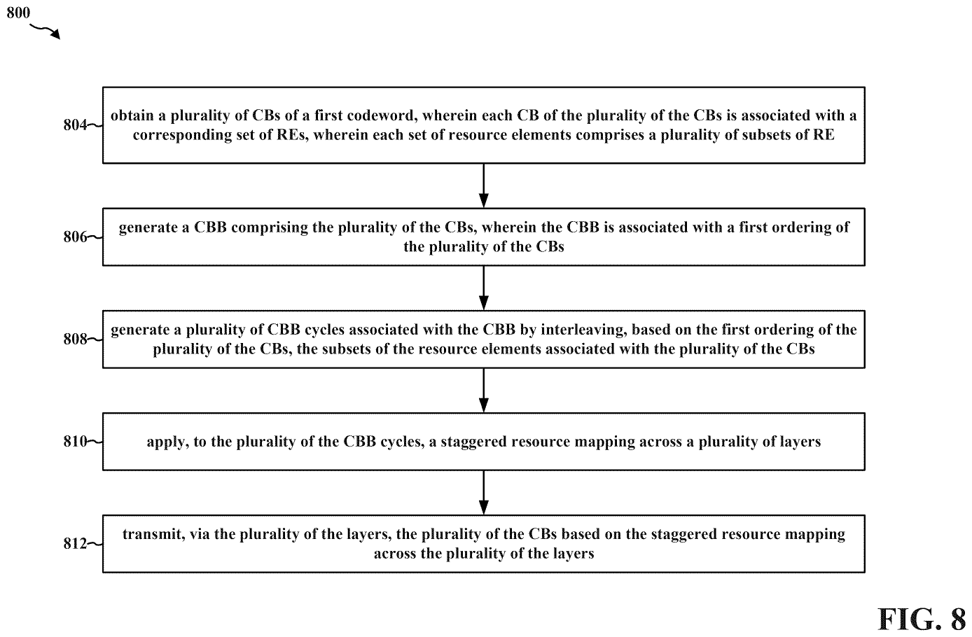

FIG. 8 is a flowchart 800 of a method of wireless communication. The method may be performed by transmitting wireless device (or transmitter) such as a UE (e.g., the UE 104, 704; the apparatus 1004) or a base station (e.g., the base station 102; the network entity 1002, 1102). The transmitter, in some aspects, may obtain a CBB-based layer mapping configuration. In some aspects, the transmitted may obtain the CBB-based layer mapping configuration by being preprogrammed with the CBB-based layer mapping configuration or may receive the CBB-based layer mapping configuration via an RRC message and/or signaling. For example, referring to FIG. 7, the UE 704 (as an example of a transmitter and/or transmitting wireless device) may obtain the CBB-based layer mapping configuration at 710, and obtaining the CBB-based layer mapping configuration at 710 may include receiving the CBB-based layer mapping configuration 712.

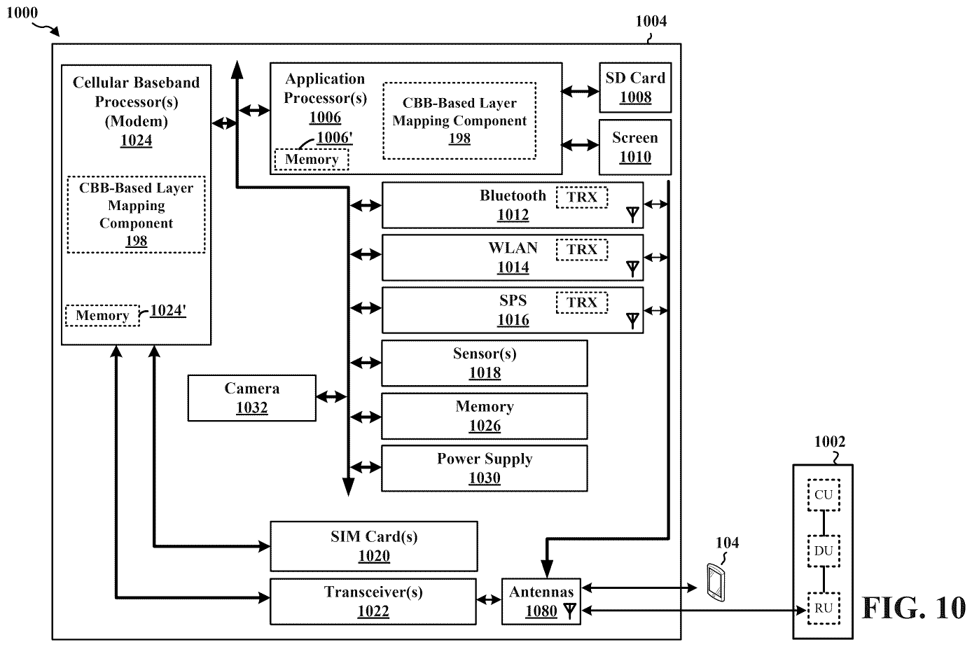

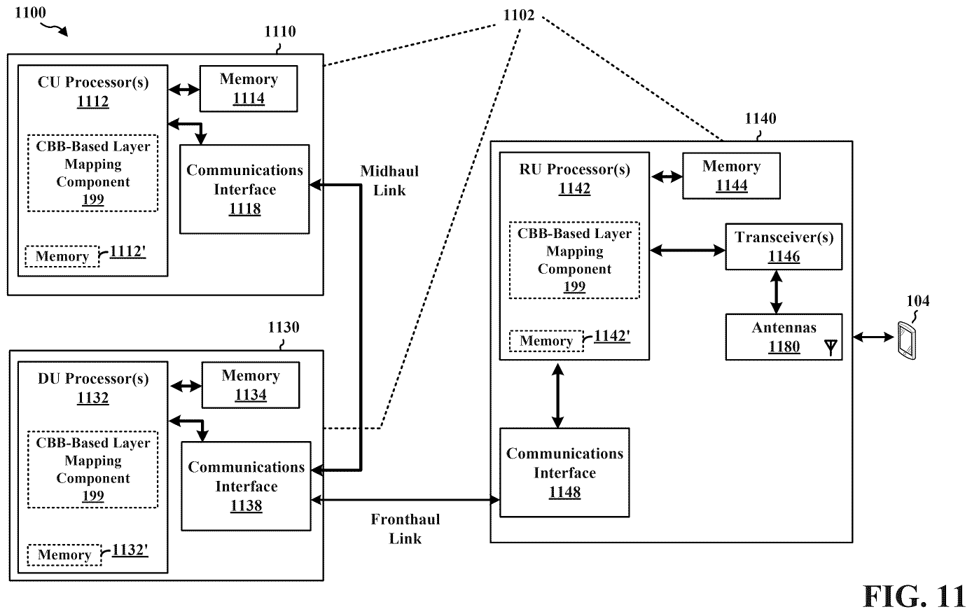

At 804, the transmitter may obtain a plurality of CBs of a first codeword. For example, 804 may be performed by application processor(s) 1006, cellular baseband processor(s) 1024, transceiver(s) 1022, antenna(s) 1080, and/or CBB-based layer mapping component 198 of FIG. 10 or by CU processor(s) 1112, DU processor(s) 1132, RU processor(s) 1142, transceiver(s) 1146, antenna(s) 1180, and/or CBB-based layer mapping component 199 of FIG. 11. In some aspects, each CB of the plurality of the CBs may be associated with a corresponding set of resource elements and each set of resource elements may include a plurality of subsets of resource elements. For example, referring to FIG. 7, the UE 704 may obtain the plurality of CBs at 714.

At 806, the transmitter may generate a CBB including the plurality of the CBs. For example, 806 may be performed by application processor(s) 1006, cellular baseband processor(s) 1024, transceiver(s) 1022, antenna(s) 1080, and/or CBB-based layer mapping component 198 of FIG. 10 or by CU processor(s) 1112, DU processor(s) 1132, RU processor(s) 1142, transceiver(s) 1146, antenna(s) 1180, and/or CBB-based layer mapping component 199 of FIG. 11. In some aspects, the CBB may be associated with a first ordering of the plurality of the CBs. For example, referring to FIG. 7, the UE 704 may generate a CBB including the plurality of the CBs obtained at 714.

At 808, the transmitter may generate a plurality of CBB cycles associated with the CBB by interleaving, based on the first ordering of the plurality of the CB s, the subsets of the resource elements associated with the plurality of the CBs. For example, 808 may be performed by application processor(s) 1006, cellular baseband processor(s) 1024, transceiver(s) 1022, antenna(s) 1080, and/or CBB-based layer mapping component 198 of FIG. 10 or by CU processor(s) 1112, DU processor(s) 1132, RU processor(s) 1142, transceiver(s) 1146, antenna(s) 1180, and/or CBB-based layer mapping component 199 of FIG. 11. In some aspects, each CBB cycle may include, for each of the plurality of the CBs associated with the CBB, one of the subsets of the resource elements associated with the CB of the plurality of CBs. The order of the subsets of the resource elements in each CBB cycle, in some aspects, may be based on the first ordering of the plurality of the CBs. For example, referring to FIG. 7, the UE 704 may, at 718, generate a plurality of CBB cycles associated with the CBB by interleaving, based on the first ordering of the plurality of the CBs, the subsets of the resource elements associated with the plurality of the CBs (e.g., as illustrated in FIG. 5).

At 810, the transmitter may apply, to the plurality of the CBB cycles, a staggered resource mapping across a plurality of layers. For example, 810 may be performed by application processor(s) 1006, cellular baseband processor(s) 1024, transceiver(s) 1022, antenna(s) 1080, and/or CBB-based layer mapping component 198 of FIG. 10 or by CU processor(s) 1112, DU processor(s) 1132, RU processor(s) 1142, transceiver(s) 1146, antenna(s) 1180, and/or CBB-based layer mapping component 199 of FIG. 11. In some aspects, the application may be associated with an offset (e.g., a staggering) between CBB cycles mapped to a first layer and CBB cycles mapped to a second layer. The offset may be configured in the CBB-based layer mapping configuration. For example, referring to FIG. 7, the UE 704 may, at 720, apply, to the plurality of the CBB cycles, a staggered resource mapping across a plurality of layers (e.g., the CBB-based staggered layer mapping illustrated in any of diagram 620, diagram 630, diagram 640, diagram 650, diagram 660, or diagram 670 of FIG. 6).

At 812, the transmitter may transmit, via the plurality of the layers, the plurality of the CB's based on the staggered resource mapping across the plurality of the layers. In some aspects, transmitting the plurality of CB s at 812 may include transmitting a first CBB cycle of the plurality of CBB cycles via a first set of time-and-frequency resources associated with a first layer, and transmitting a second CBB cycle of the plurality of CBB cycles via a second set of time-and-frequency resources associated with a second layer. For example, 812 may be performed by application processor(s) 1006, cellular baseband processor(s) 1024, transceiver(s) 1022, antenna(s) 1080, and/or CBB-based layer mapping component 198 of FIG. 10 or by CU processor(s) 1112, DU processor(s) 1132, RU processor(s) 1142, transceiver(s) 1146, antenna(s) 1180, and/or CBB-based layer mapping component 199 of FIG. 11. In some aspects, an offset between the first set of time-and-frequency resources and the second set of time-and-frequency resources may include an integer multiple of the first number of resource elements, where the offset is less than the second number of resource elements. A transmission power for a first CB in the plurality of CBs associated with the CBB, in some aspects, may be based on a fraction of first resource elements in a first set of the resource elements associated with the first CB that are free of interference. In some aspects, a MCS for a first CB in the plurality of CBs associated with the CBB may be based on a fraction of first resource elements in a first set of the resource elements associated with the first CB that are free of interference. A particular resource element may be free of the interference if one of: (1) the first time-and-frequency resources associated with a different layer of the plurality of layers are not used to transmit other resource elements associated with a different CB in the plurality of CBs, or (2) additional resource elements that are transmitted via the first time-and-frequency resources associated with one or more of the different layers of the plurality of layers, are associated with one or more CBs in the plurality of CBs that are able to be canceled in association with a successive cancellation decoding before decoding the first CB. A transmission power and/or MCS corresponding to a particular fraction of interference-free resources (or REs) may, in some aspects, be identified based on the CBB-based layer mapping configuration. In some aspects, the transmission power may be inversely related to the fraction of the plurality of the sets of the resource elements associated with the CB that are free of the interference. The MCS, in some aspects, may be selected from a set of candidate M CSs corresponding to a set of disjoint ranges of the fraction, where the set of candidate M CSs and the corresponding set of disjoint ranges of the fraction are one of known or configured via RRC messaging. For example, referring to FIG. 7, the UE 704 may transmit transmission 722 based on the application, at 720, the staggered resource mapping across a plurality of layers to the plurality of the CBB cycles (e.g., the CBB-based staggered layer mapping illustrated in any of diagram 620, diagram 630, diagram 640, diagram 650, diagram 660, or diagram 670 of FIG. 6).

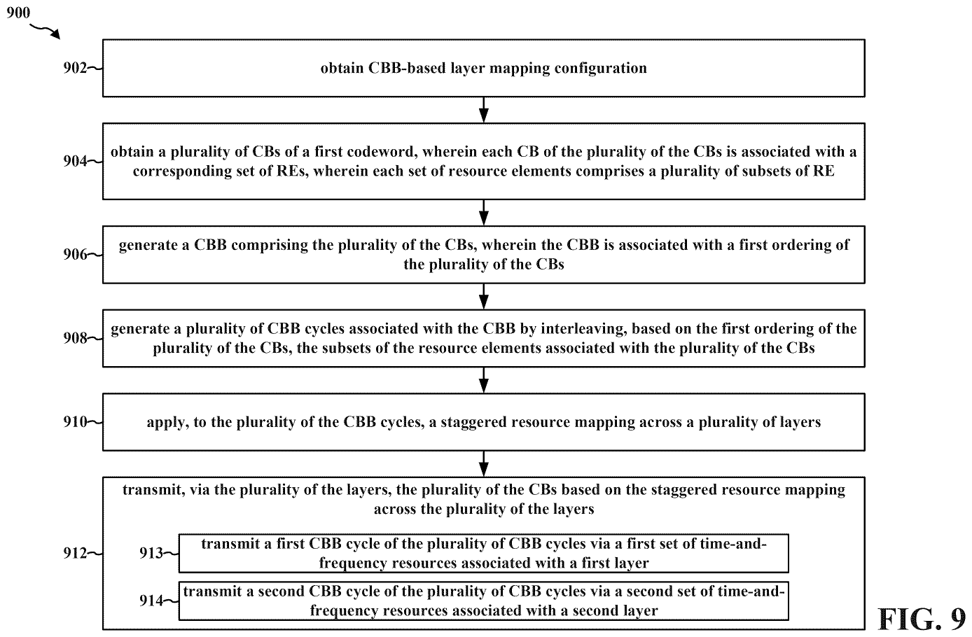

FIG. 9 is a flowchart 900 of a method of wireless communication. The method may be performed by transmitting wireless device (or transmitter) such as a UE (e.g., the UE 104, 704; the apparatus 1004) or a base station (e.g., the base station 102; the network entity 1002, 1102). At 902, the transmitter may obtain a CBB-based layer mapping configuration. For example, 902 may be performed by application processor(s) 1006, cellular baseband processor(s) 1024, transceiver(s) 1022, antenna(s) 1080, and/or CBB-based layer mapping component 198 of FIG. 10 or by CU processor(s) 1112, DU processor(s) 1132, RU processor(s) 1142, transceiver(s) 1146, antenna(s) 1180, and/or CBB-based layer mapping component 199 of FIG. 11. In some aspects, the transmitted may obtain the CBB-based layer mapping configuration by being preprogrammed with the CBB-based layer mapping configuration or may receive the CBB-based layer mapping configuration via an RRC message and/or signaling. For example, referring to FIG. 7, the UE 704 (as an example of a transmitter and/or transmitting wireless device) may obtain the CBB-based layer mapping configuration at 710, and obtaining the CBB-based layer mapping configuration at 710 may include receiving the CBB-based layer mapping configuration 712.

At 904, the transmitter may obtain a plurality of CB s of a first codeword. For example, 904 may be performed by application processor(s) 1006, cellular baseband processor(s) 1024, transceiver(s) 1022, antenna(s) 1080, and/or CBB-based layer mapping component 198 of FIG. 10 or by CU processor(s) 1112, DU processor(s) 1132, RU processor(s) 1142, transceiver(s) 1146, antenna(s) 1180, and/or CBB-based layer mapping component 199 of FIG. 11. In some aspects, each CB of the plurality of the CBs may be associated with a corresponding set of resource elements and each set of resource elements may include a plurality of subsets of resource elements. For example, referring to FIG. 7, the UE 704 may obtain the plurality of CBs at 714.

At 906, the transmitter may generate a CBB including the plurality of the CBs. For example, 906 may be performed by application processor(s) 1006, cellular baseband processor(s) 1024, transceiver(s) 1022, antenna(s) 1080, and/or CBB-based layer mapping component 198 of FIG. 10 or by CU processor(s) 1112, DU processor(s) 1132, RU processor(s) 1142, transceiver(s) 1146, antenna(s) 1180, and/or CBB-based layer mapping component 199 of FIG. 11. In some aspects, the CBB may be associated with a first ordering of the plurality of the CBs. For example, referring to FIG. 7, the UE 704 may generate a CBB including the plurality of the CBs obtained at 714.

At 908, the transmitter may generate a plurality of CBB cycles associated with the CBB by interleaving, based on the first ordering of the plurality of the CB s, the subsets of the resource elements associated with the plurality of the CBs. For example, 908 may be performed by application processor(s) 1006, cellular baseband processor(s) 1024, transceiver(s) 1022, antenna(s) 1080, and/or CBB-based layer mapping component 198 of FIG. 10 or by CU processor(s) 1112, DU processor(s) 1132, RU processor(s) 1142, transceiver(s) 1146, antenna(s) 1180, and/or CBB-based layer mapping component 199 of FIG. 11. In some aspects, each CBB cycle may include, for each of the plurality of the CBs associated with the CBB, one of the subsets of the resource elements associated with the CB of the plurality of CBs. The order of the subsets of the resource elements in each CBB cycle, in some aspects, may be based on the first ordering of the plurality of the CBs. For example, referring to FIG. 7, the UE 704 may, at 718, generate a plurality of CBB cycles associated with the CBB by interleaving, based on the first ordering of the plurality of the CBs, the subsets of the resource elements associated with the plurality of the CBs (e.g., as illustrated in FIG. 5).

At 910, the transmitter may apply, to the plurality of the CBB cycles, a staggered resource mapping across a plurality of layers. For example, 910 may be performed by application processor(s) 1006, cellular baseband processor(s) 1024, transceiver(s) 1022, antenna(s) 1080, and/or CBB-based layer mapping component 198 of FIG. 10 or by CU processor(s) 1112, DU processor(s) 1132, RU processor(s) 1142, transceiver(s) 1146, antenna(s) 1180, and/or CBB-based layer mapping component 199 of FIG. 11. In some aspects, the application may be associated with an offset (e.g., a staggering) between CBB cycles mapped to a first layer and CBB cycles mapped to a second layer. The offset may be configured in the CBB-based layer mapping configuration. For example, referring to FIG. 7, the UE 704 may, at 720, apply, to the plurality of the CBB cycles, a staggered resource mapping across a plurality of layers (e.g., the CBB-based staggered layer mapping illustrated in any of diagram 620, diagram 630, diagram 640, diagram 650, diagram 660, or diagram 670 of FIG. 6).

At 912, the transmitter may transmit, via the plurality of the layers, the plurality of the CB's based on the staggered resource mapping across the plurality of the layers. In some aspects, transmitting the plurality of CBs at 912 may include, at 913, transmitting a first CBB cycle of the plurality of CBB cycles via a first set of time-and-frequency resources associated with a first layer, and, at 914, transmitting a second CBB cycle of the plurality of CBB cycles via a second set of time-and-frequency resources associated with a second layer. For example, 912-914 may be performed by application processor(s) 1006, cellular baseband processor(s) 1024, transceiver(s) 1022, antenna(s) 1080, and/or CBB-based layer mapping component 198 of FIG. 10 or by CU processor(s) 1112, DU processor(s) 1132, RU processor(s) 1142, transceiver(s) 1146, antenna(s) 1180, and/or CBB-based layer mapping component 199 of FIG. 11. In some aspects, an offset between the first set of time-and-frequency resources and the second set of time-and-frequency resources may include an integer multiple of the first number of resource elements, where the offset is less than the second number of resource elements. A transmission power for a first CB in the plurality of CBs associated with the CBB, in some aspects, may be based on a fraction of first resource elements in a first set of the resource elements associated with the first CB that are free of interference. In some aspects, a MCS for a first CB in the plurality of CBs associated with the CBB may be based on a fraction of first resource elements in a first set of the resource elements associated with the first CB that are free of interference. A particular resource element may be free of the interference if one of: (1) the first time-and-frequency resources associated with a different layer of the plurality of layers are not used to transmit other resource elements associated with a different CB in the plurality of CBs, or (2) additional resource elements that are transmitted via the first time-and-frequency resources associated with one or more of the different layers of the plurality of layers, are associated with one or more CBs in the plurality of CBs that are able to be canceled in association with a successive cancellation decoding before decoding the first CB. A transmission power and/or MCS corresponding to a particular fraction of interference-free resources (or REs) may, in some aspects, be identified based on the CBB-based layer mapping configuration. In some aspects, the transmission power may be inversely related to the fraction of the plurality of the sets of the resource elements associated with the CB that are free of the interference. The MCS, in some aspects, may be selected from a set of candidate M CSs corresponding to a set of disjoint ranges of the fraction, where the set of candidate M CSs and the corresponding set of disjoint ranges of the fraction are one of known or configured via RRC messaging. For example, referring to FIG. 7, the UE 704 may transmit transmission 722 based on the application, at 720, the staggered resource mapping across a plurality of layers to the plurality of the CBB cycles (e.g., the CBB-based staggered layer mapping illustrated in any of diagram 620, diagram 630, diagram 640, diagram 650, diagram 660, or diagram 670 of FIG. 6).

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IM U), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize one or more antennas 1080 for communication. The cellular baseband processor(s) 1024 communicates through the transceiver(s) 1022 via the one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The cellular baseband processor(s) 1024 and the application processor(s) 1006 are configured to perform the various functions described supra based at least in part of the information stored in the memory. That is, the cellular baseband processor(s) 1024 and the application processor(s) 1006 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the CBB-based layer mapping component 198 may be configured to obtain a plurality of CBs of a first codeword, wherein each CB of the plurality of the CB s is associated with a corresponding set of resource elements, wherein each set of resource elements comprises a plurality of subsets of resource elements, generate a CBB comprising the plurality of the CBs, wherein the CBB is associated with a first ordering of the plurality of the CBs, generate a plurality of CBB cycles associated with the CBB by interleaving, based on the first ordering of the plurality of the CBS, the subsets of the resource elements associated with the plurality of the CBs, apply, to the plurality of the CBB cycles, a staggered resource mapping across a plurality of layers, and transmit, via the plurality of the layers, the plurality of the CBs based on the staggered resource mapping across the plurality of the layers. The apparatus 1004 and/or the CBB-based layer mapping component 198 may be further configured to perform any of the aspects described in connection with the flowcharts in FIG. 8 or 9, and/or performed by the UE in the communication flow of FIG. 7. The CBB-based layer mapping component 198 may be within the cellular baseband processor(s) 1024, the application processor(s) 1006, or both the cellular baseband processor(s) 1024 and the application processor(s) 1006. The CBB-based layer mapping component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for obtaining a plurality of CBs of a first codeword, wherein each CB of the plurality of the CBs is associated with a corresponding set of resource elements, wherein each set of resource elements comprises a plurality of subsets of resource elements. The apparatus 1004, and in particular the cellular baseband processor(s) 1024 and/or the application processor(s) 1006, may include means for generating a CB bundle (CBB) comprising the plurality of the CBs, wherein the CBB is associated with a first ordering of the plurality of the CBs. The apparatus 1004, and in particular the cellular baseband processor(s) 1024 and/or the application processor(s) 1006, may include means for generating a plurality of CBB cycles associated with the CBB by interleaving, based on the first ordering of the plurality of the CBs, the subsets of the resource elements associated with the plurality of the CBs. The apparatus 1004, and in particular the cellular baseband processor(s) 1024 and/or the application processor(s) 1006, may include means for applying, to the plurality of the CBB cycles, a staggered resource mapping across a plurality of layers. The apparatus 1004, and in particular the cellular baseband processor(s) 1024 and/or the application processor(s) 1006, may include means for transmitting, via the plurality of the layers, the plurality of the CBs based on the staggered resource mapping across the plurality of the layers. The apparatus 1004, and in particular the cellular baseband processor(s) 1024 and/or the application processor(s) 1006, may include means for transmitting a first CBB cycle of the plurality of CBB cycles via a first set of time-and-frequency resources associated with a first layer. The apparatus 1004, and in particular the cellular baseband processor(s) 1024 and/or the application processor(s) 1006, may include means for transmitting a second CBB cycle of the plurality of CBB cycles via a second set of time-and-frequency resources associated with a second layer, wherein an offset between the first set of time-and-frequency resources and the second set of time-and-frequency resources comprises an integer multiple of the first number of resource elements, wherein the offset is less than the second number of resource elements. The apparatus 1004, and in particular the cellular baseband processor(s) 1024 and/or the application processor(s) 1006, may include means for receiving, via RRC signaling, a configuration of the staggered resource mapping across a plurality of layers. The apparatus 1004 may further include means for performing any of the aspects described in connection with the flowcharts in FIG. 8 or 9, and/or performed by the UE in the communication flow of FIG. 7. The means may be the CBB-based layer mapping component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the CBB-based layer mapping component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 11321. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, one or more antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the CBB-based layer mapping component 199 may be configured to obtain a plurality of CBs of a first codeword, wherein each CB of the plurality of the CBs is associated with a corresponding set of resource elements, wherein each set of resource elements comprises a plurality of subsets of resource elements, generate a CBB comprising the plurality of the CBs, wherein the CBB is associated with a first ordering of the plurality of the CBs, generate a plurality of CBB cycles associated with the CBB by interleaving, based on the first ordering of the plurality of the CBS, the subsets of the resource elements associated with the plurality of the CBs, apply, to the plurality of the CBB cycles, a staggered resource mapping across a plurality of layers, and transmit, via the plurality of the layers, the plurality of the CBs based on the staggered resource mapping across the plurality of the layers. The CBB-based layer mapping component 199 and/or the network entity 1102 may be further configured to perform any of the aspects described in connection with the flowchart in FIGS. 8 and 9, and/or performed by the base station in the communication flow of FIG. 7. The CBB-based layer mapping component 199 may be within one or more processors of one or more of the CU 1110, DU 1130, and the RU 1140. The CBB-based layer mapping component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 may include means for obtaining a plurality of code blocks (CBs) of a first codeword, wherein each CB of the plurality of the CBs is associated with a corresponding set of resource elements, wherein each set of resource elements comprises a plurality of subsets of resource elements. The network entity 1102, in some aspects, may include means for generating a CB bundle (CBB) comprising the plurality of the CBs, wherein the CBB is associated with a first ordering of the plurality of the CBs. The network entity 1102, in some aspects, may include means for generating a plurality of CBB cycles associated with the CBB by interleaving, based on the first ordering of the plurality of the CBs, the subsets of the resource elements associated with the plurality of the CBs. The network entity 1102, in some aspects, may include means for applying, to the plurality of the CBB cycles, a staggered resource mapping across a plurality of layers. The network entity 1102, in some aspects, may include means for transmitting, via the plurality of the layers, the plurality of the CBs based on the staggered resource mapping across the plurality of the layers. The network entity 1102, in some aspects, may include means for transmitting a first CBB cycle of the plurality of CBB cycles via a first set of time-and-frequency resources associated with a first layer. The network entity 1102, in some aspects, may include means for transmitting a second CBB cycle of the plurality of CBB cycles via a second set of time-and-frequency resources associated with a second layer, wherein an offset between the first set of time-and-frequency resources and the second set of time-and-frequency resources comprises an integer multiple of the first number of resource elements, wherein the offset is less than the second number of resource elements. The network entity 1102, in some aspects, may include means for receiving, via RRC signaling, a configuration of the staggered resource mapping across a plurality of layers. The network entity 1102 may further include means for performing any of the aspects described in connection with the flowchart in FIGS. 8 and 9, and/or performed by the base station in the communication flow of FIG. 7. The means may be the CBB-based layer mapping component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects relate generally to the introduction of frequency interleaving based on code block bundling (CBB) to a staggered SC-MIMO. In some aspects, introducing frequency diversity by interleaving CBs in a code block bundle (CBB) may increase a rate loss based on the larger size of a CBB unit and corresponding set of empty resources to allow for a decoding of a first CBB unit. Some aspects more specifically relate to methods to reduce rate loss by manipulating a staggering method (or introducing a modified staggering method) such that, instead of having empty resources corresponding to a full CBB, the empty resources correspond to a subset of the CBs in the CBB. In some examples, configured to obtain a plurality of CBs of a first codeword, wherein each CB of the plurality of the CBs is associated with a corresponding set of resource elements, wherein each set of resource elements comprises a plurality of subsets of resource elements, generate a CBB comprising the plurality of the CBs, wherein the CBB is associated with a first ordering of the plurality of the CBs, generate a plurality of CBB cycles associated with the CBB by interleaving, based on the first ordering of the plurality of the CBs, the subsets of the resource elements associated with the plurality of the CBs, apply, to the plurality of the CBB cycles, a staggered resource mapping across a plurality of layers, and transmit, via the plurality of the layers, the plurality of the CB s based on the staggered resource mapping across the plurality of the layers.

Particular aspects of the subject matter described in this disclosure can be implemented to realize one or more of the following potential advantages. In some examples, by introducing frequency diversity by interleaving CBs in a code block bundle using the modified staggering method, the described techniques can be used to improve the frequency diversity for a CB while maintaining a rate loss associated with the unmodified staggering method.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S=F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a transmitting device, comprising: obtaining a plurality of code blocks (CBs) of a first codeword, wherein each CB of the plurality of the CBs is associated with a corresponding set of resource elements, wherein each set of resource elements comprises a plurality of subsets of resource elements; generating a CB bundle (CBB) comprising the plurality of the CBs, wherein the CBB is associated with a first ordering of the plurality of the CBs; generating a plurality of CBB cycles associated with the CBB by interleaving, based on the first ordering of the plurality of the CBs, the subsets of the resource elements associated with the plurality of the CBs; applying, to the plurality of the CBB cycles, a staggered resource mapping across a plurality of layers; and transmitting, via the plurality of the layers, the plurality of the CBs based on the staggered resource mapping across the plurality of the layers.

Aspect 2 is the method of aspect 1, wherein each CBB cycle comprises, for each of the plurality of the CBs associated with the CBB, one of the subsets of the resource elements associated with the CB of the plurality of CBs, wherein the order of the subsets of the resource elements in each CBB cycle is based on the first ordering of the plurality of the CBs.

Aspect 3 is the method of aspect 2, wherein the subsets of the resource elements associated with the plurality of the CBs each comprise a first number of resource elements and each CBB cycle comprises a second number of resource elements based on the first number of resource elements and a third number of the CBs in the plurality of the CBs, wherein transmitting the plurality of the CBs comprises: transmitting a first CBB cycle of the plurality of CBB cycles via a first set of time-and-frequency resources associated with a first layer; and transmitting a second CBB cycle of the plurality of CBB cycles via a second set of time-and-frequency resources associated with a second layer, wherein an offset between the first set of time-and-frequency resources and the second set of time-and-frequency resources comprises an integer multiple of the first number of resource elements, wherein the offset is less than the second number of resource elements.

Aspect 4 is the method of any of aspects 1 to 3, wherein a transmission power for a first CB in the plurality of CBs associated with a CBB is based on a fraction of first resource elements in a first set of the resource elements associated with the first CB that are free of interference, wherein a particular resource element of the first resource elements of the first set of the resource elements is transmitted via first time-and-frequency resources associated with a first layer, and wherein the particular resource element is free of the interference if one of: the first time-and-frequency resources associated with a different layer of the plurality of layers are not used to transmit other resource elements associated with a different CB in the plurality of CBs; or additional resource elements that are transmitted via the first time-and-frequency resources associated with one or more of the different layers of the plurality of layers, are associated with one or more CBs in the plurality of CBs that are able to be canceled in association with a successive cancellation decoding before decoding the first CB.

Aspect 5 is the method of aspect 4, wherein the transmission power is inversely related to the fraction of the plurality of the sets of the resource elements associated with the CB that are free of the interference.

Aspect 6 is the method of any of aspects 1 to 5, wherein a modulation and coding scheme (MCS) for a CB in the plurality of CBs is based on a fraction of first resource elements in a first set of the resource elements associated with the first CB that are free of interference, wherein a particular resource element of the first resource elements of the first set of the resource elements is transmitted via first time-and-frequency resources associated with a first layer, and wherein the particular resource element is free of the interference if one of: the first time-and-frequency resources associated with a different layer of the plurality of layers are not used to transmit other resource elements associated with a different CB in the plurality of CBs; or additional resource elements that are transmitted via the first time-and-frequency resources associated with one or more of the different layers of the plurality of layers, are associated with one or more CBs in the plurality of CBs that are able to be canceled in association with a successive cancellation decoding before decoding the first CB.

Aspect 7 is the method of aspect 6, wherein the MCS is selected from a set of candidate M CSs corresponding to a set of disjoint ranges of the fraction.

Aspect 8 is the method of aspect 7, wherein the set of candidate M CSs and the corresponding set of disjoint ranges of the fraction are one of known or configured via radio resource control (RRC) messaging.

Aspect 9 is an apparatus for wireless communication at a transmitting device, comprising: at least one memory; and at least one processor coupled to the at least one memory, the at least one processor is configured to perform the method of any of aspects 1 to 8.

Aspect 10 is an apparatus for wireless communication at a transmitting device, comprising means for performing each step in the method of any of aspects 1 to 8.

Aspect 11 is the apparatus of any of aspects 9 to 10 further comprising a transceiver configured to receive or to transmit in association with the method of any of aspects 1 to 8.

Aspect 12 is a computer-readable medium storing computer executable code at a transmitting device, the code when executed by at least one processor causes the at least one processor to perform the method of any of aspects 1 to 8.

What is claimed is:

1. An apparatus for wireless communication at a transmitting device, comprising:
at least one memory; and
at least one processor coupled to the at least one memory and, based at least in part on information stored in the at least one memory, the at least one processor is configured to:
obtain a plurality of code blocks (CBs) of a first codeword, wherein each CB of the plurality of the CBs is associated with a corresponding set of resource elements, wherein each set of resource elements comprises a plurality of subsets of resource elements;
generate a CB bundle (CBB) comprising the plurality of the CBs, wherein the CBB is associated with a first ordering of the plurality of the CBs;
generate a plurality of CBB cycles associated with the CBB by interleaving, based on the first ordering of the plurality of the CBs, the subsets of the resource elements associated with the plurality of the CBS;
apply, to the plurality of the CBB cycles, a staggered resource mapping across a plurality of layers; and
transmit, via the plurality of the layers, the plurality of the CBs based on the staggered resource mapping across the plurality of the layers.

2. The apparatus of claim 1, wherein each CBB cycle comprises, for each of the plurality of the C Bs associated with the CBB, one of the subsets of the resource elements associated with the CB of the plurality of CBs, wherein a second ordering of the subsets of the resource elements in each CBB cycle is based on the first ordering of the plurality of the CBs.

3. The apparatus of claim 2, further comprising a transceiver coupled to the at least one processor, wherein the subsets of the resource elements associated with the plurality of the CB s each comprise a first number of resource elements and each CBB cycle comprises a second number of resource elements based on the first number of resource elements and a third number of the CBs in the plurality of the CBs, wherein to transmit the plurality of the CBs, the at least one processor is configured to:
transmit, via the transceiver, a first CBB cycle of the plurality of CBB cycles via a first set of time-and-frequency resources associated with a first layer; and
transmit, via the transceiver, a second CBB cycle of the plurality of CBB cycles via a second set of time-and-frequency resources associated with a second layer, wherein an offset between the first set of time-and-frequency resources and the second set of time-and-frequency resources comprises an integer multiple of the first number of resource elements, wherein the offset is less than the second number of resource elements.

4. The apparatus of claim 1, wherein a transmission power for a first CB in the plurality of CBs associated with the CBB is based on a fraction of first resource elements in a first set of the resource elements associated with the first CB that are free of interference, wherein a particular resource element of the first resource elements of the first set of the resource elements is transmitted via first time-and-frequency resources associated with a first layer, and wherein the particular resource element is free of the interference if one of:
the first time-and-frequency resources associated with a different layer of the plurality of layers are not used to transmit other resource elements associated with a different CB in the plurality of CBs; or
additional resource elements that are transmitted via the first time-and-frequency resources associated with one or more of the different layers of the plurality of layers, are associated with one or more CBs in the plurality of CBs that are able to be canceled in association with a successive cancellation decoding before decoding the first CB.

5. The apparatus of claim 4, wherein the transmission power is inversely related to the fraction of the plurality of the sets of the resource elements associated with the CB that are free of the interference.

6. The apparatus of claim 1, wherein a modulation and coding scheme (MCS) for a first CB in the plurality of CB s associated with the CBB is based on a fraction of first resource elements in a first set of the resource elements associated with the first CB that are free of interference, wherein a particular resource element of the first resource elements of the first set of the resource elements is transmitted via first time-and-frequency resources associated with a first layer, and wherein the particular resource element is free of the interference if one of:
the first time-and-frequency resources associated with a different layer of the plurality of layers are not used to transmit other resource elements associated with a different CB in the plurality of CBs; or
additional resource elements that are transmitted via the first time-and-frequency resources associated with one or more of the different layers of the plurality of layers, are associated with one or more CBs in the plurality of CBs that are able to be canceled in association with a successive cancellation decoding before decoding the first CB.

7. The apparatus of claim 6, wherein the at least one processor is further configured to:
select the MCS from a set of candidate M CSs corresponding to a set of disjoint ranges of the fraction.

8. The apparatus of claim 7, wherein the set of candidate M CSs and the corresponding set of disjoint ranges of the fraction are one of known or configured via radio resource control (RRC) messaging.

9. A method of wireless communication at a transmitting device, comprising:
obtaining a plurality of code blocks (CBs) of a first codeword, wherein each CB of the plurality of the CBs is associated with a corresponding set of resource elements, wherein each set of resource elements comprises a plurality of subsets of resource elements;
generating a CB bundle (CBB) comprising the plurality of the CBs, wherein the CBB is associated with a first ordering of the plurality of the CBS;
generating a plurality of CBB cycles associated with the CBB by interleaving, based on the first ordering of the plurality of the CBs, the subsets of the resource elements associated with the plurality of the CBS;
applying, to the plurality of the CBB cycles, a staggered resource mapping across a plurality of layers; and
transmitting, via the plurality of the layers, the plurality of the CBs based on the staggered resource mapping across the plurality of the layers.

10. The method of claim 9, wherein each CBB cycle comprises, for each of the plurality of the CBs associated with the CBB, one of the subsets of the resource elements associated with the CB of the plurality of CBs, wherein the order of the subsets of the resource elements in each CBB cycle is based on the first ordering of the plurality of the CBs.

11. The method of claim 10, wherein the subsets of the resource elements associated with the plurality of the CBs each comprise a first number of resource elements and each CBB cycle comprises a second number of resource elements based on the first number of resource elements and a third number of the CBs in the plurality of the CBs, wherein transmitting the plurality of the CBs comprises:
transmitting a first CBB cycle of the plurality of CBB cycles via a first set of time-and-frequency resources associated with a first layer; and
transmitting a second CBB cycle of the plurality of CBB cycles via a second set of time-and-frequency resources associated with a second layer, wherein an offset between the first set of time-and-frequency resources and the second set of time-and-frequency resources comprises an integer multiple of the first number of resource elements, wherein the offset is less than the second number of resource elements.

12. The method of claim 9, wherein a transmission power for a first CB in the plurality of CBs associated with a CBB is based on a fraction of first resource elements in a first set of the resource elements associated with the first CB that are free of interference, wherein a particular resource element of the first resource elements of the first set of the resource elements is transmitted via first time-and-frequency resources associated with a first layer, and wherein the particular resource element is free of the interference if one of:
the first time-and-frequency resources associated with a different layer of the plurality of layers are not used to transmit other resource elements associated with a different CB in the plurality of CBs; or
additional resource elements that are transmitted via the first time-and-frequency resources associated with one or more of the different layers of the plurality of layers, are associated with one or more CBs in the plurality of CBs that are able to be canceled in association with a successive cancellation decoding before decoding the first CB.

13. The method of claim 12, wherein the transmission power is inversely related to the fraction of the plurality of the sets of the resource elements associated with the CB that are free of the interference.

14. The method of claim 9, wherein a modulation and coding scheme (MCS) for a CB in the plurality of CBs is based on a fraction of first resource elements in a first set of the resource elements associated with the first CB that are free of interference, wherein a particular resource element of the first resource elements of the first set of the resource elements is transmitted via first time-and-frequency resources associated with a first layer, and wherein the particular resource element is free of the interference if one of:
the first time-and-frequency resources associated with a different layer of the plurality of layers are not used to transmit other resource elements associated with a different CB in the plurality of CBs; or
additional resource elements that are transmitted via the first time-and-frequency resources associated with one or more of the different layers of the plurality of layers, are associated with one or more CBs in the plurality of CBs that are able to be canceled in association with a successive cancellation decoding before decoding the first CB.

15. The method of claim 14, wherein the MCS is selected from a set of candidate M CSs corresponding to a set of disjoint ranges of the fraction.

16. The method of claim 15, wherein the set of candidate M CSs and the corresponding set of disjoint ranges of the fraction are one of known or configured via radio resource control (RRC) messaging.

17. A computer-readable medium storing computer executable code at a transmitting device, the code when executed by at least one processor causes the at least one processor to:
obtain a plurality of code blocks (CBs) of a first codeword, wherein each CB of the plurality of the CBs is associated with a corresponding set of resource elements, wherein each set of resource elements comprises a plurality of subsets of resource elements;
generate a CB bundle (CBB) comprising the plurality of the CBs, wherein the CBB is associated with a first ordering of the plurality of the CBS;
generate a plurality of CBB cycles associated with the CBB by interleaving, based on the first ordering of the plurality of the CBs, the subsets of the resource elements associated with the plurality of the CBS;
apply, to the plurality of the CBB cycles, a staggered resource mapping across a plurality of layers; and
transmit, via the plurality of the layers, the plurality of the CBs based on the staggered resource mapping across the plurality of the layers.

18. The computer-readable medium of claim 17, wherein each CBB cycle comprises, for each of the plurality of the CB s associated with the CBB, one of the subsets of the resource elements associated with the CB of the plurality of CBs, wherein the order of the subsets of the resource elements in each CBB cycle is based on the first ordering of the plurality of the CBs.

19. The computer-readable medium of claim 18, wherein the subsets of the resource elements associated with the plurality of the CBs each comprise a first number of resource elements and each CBB cycle comprises a second number of resource elements based on the first number of resource elements and a third number of the CBs in the plurality of the CBs, wherein to transmit the plurality of the CBs, the code when executed by the at least one processor causes the at least one processor to:
transmit a first CBB cycle of the plurality of CBB cycles via a first set of time-and-frequency resources associated with a first layer; and
transmit a second CBB cycle of the plurality of CBB cycles via a second set of time-and-frequency resources associated with a second layer, wherein an offset between the first set of time-and-frequency resources and the second set of time-and-frequency resources comprises an integer multiple of the first number of resource elements, wherein the offset is less than the second number of resource elements.

20. The computer-readable medium of claim 17, wherein one or more of a transmission power for a first CB in the plurality of CBs associated with the CBB or a modulation and coding scheme (MCS) for the first CB in the plurality of CBs associated with the CBB is based on a fraction of first resource elements in a first set of the resource elements associated with the first CB that are free of interference, wherein a particular resource element of the first resource elements of the first set of the resource elements is transmitted via first time-and-frequency resources associated with a first layer, and wherein the particular resource element is free of the interference if one of:
the first time-and-frequency resources associated with a different layer of the plurality of layers are not used to transmit other resource elements associated with a different CB in the plurality of CBs; or
additional resource elements that are transmitted via the first time-and-frequency resources associated with one or more of the different layers of the plurality of layers, are associated with one or more CBs in the plurality of CBs that are able to be canceled in association with a successive cancellation decoding before decoding the first CB.
